(19) United States
(12) Patent Application Publication
(10) Pub. No.: US 2015/0317890 A1
(43) Pub. Date: Nov. 5, 2015

(54) DETECTING CHANGES IN POSITION OF A DEVICE IN A HORIZONTAL OR VERTICAL DIRECTION

(71) Applicant: KONINKLIJKE PHILIPS N.V., Eindhoven (NL)

(72) Inventor: WARNER RUDOLPH THEOPHILE TEN KATE, WAALRE (NL)

(21) Appl. No.: 14/646,591

(22) PCT Filed: Nov. 12, 2013
(86) PCT No.: PCT/IB2013/060077

§ 371 Date: May 21, 2015

Related U.S. Application Data
(60) Provisional application No. 61/730,133, filed on Nov. 27, 2012.

(51) Int. Cl. G08B 21/04; G01P 15/18

(52) U.S. Cl. CPC G08B 21/0446; G01P 15/18

(57) ABSTRACT

There is provided a method for determining the change in horizontal or vertical position of a device, the method comprising obtaining a signal that represents an estimate of the position of the device in a horizontal or vertical direction over time; identifying a maximum position value and a minimum position value from a selected portion of the signal representing the estimate of the position of the device; and determining the change in position over the selected portion of the signal as the difference between the identified maximum position value and the identified minimum position value.

### TECHNICAL FIELD OF THE INVENTION

The invention relates to a method and apparatus for detecting changes in position of a device in a vertical or horizontal direction, for example a device that can be worn or carried by a user, and in particular to a method and apparatus for detecting changes in position of a device from measurements of the movement of the device.

### BACKGROUND TO THE INVENTION

Falling is a significant problem in the care of the elderly that can lead to morbidity and mortality. From a physical perspective, falls cause injuries, while from the mental perspective, falls cause fear-of-falling, which in turn leads to social isolation and depression.

Fall detection devices and systems are available that can provide an automated and reliable means for detecting when a user has fallen. If a fall is detected, the device or system issues an alarm which summons help to the user. This assures the user that adequate measures will be taken in the event that a fall occurs.

Commonly, fall detectors are based on an accelerometer (usually a 3D accelerometer that measures acceleration in three dimensions) that is part of a device to be attached to the user's body. The signals from the accelerometer are processed to determine whether a fall has taken place.

The reliability of fall detection can be improved by making use of further sensors which can be used to detect various different features that are characteristic of a fall. Important features include the impact of the user with the ground during the fall, an orientation change as the user falls, and a reduction in the height of the sensor unit above the ground. In EP 1642248, the use of an air pressure sensor is proposed to detect a change in the relative height measured by the device.

Currently available air pressure sensors provide a resolution in the relative altitude of the order of 10 cm. However, the nature of these pressure sensors means that their measurements are sensitive to gravity, and hence to the orientation of the sensor unit. This can be addressed by compensating the pressure sensor measurements for the orientation of the sensor unit, as described in WO 2009/101566. In addition, air pressure sensors clearly also respond to barometric fluctuations in the environment, and therefore the fall detector needs to verify whether the height change suggested by an increase in air pressure measurements is due (or can be due) to the motion of the sensor unit and the user. A further problem with air pressure sensors is that they increase the complexity of the mechanical construction of the device that houses the sensors. In particular, the device is required to have a fast-responding channel between the air pressure sensor inside the device and the environmental air outside, with this channel also being shielded against moisture, light, and other pollution. The presence of this channel can pose a problem in keeping the device hygienically clean, which is of particular importance when the device is used in a hospital or other healthcare environment.

Another approach to determining a measurement for the change in height is to use the accelerometer signal. By integrating the vertical acceleration signal, a measure for vertical velocity can be obtained, and by integrating the vertical velocity signal, a measure for position/height can be obtained. The integration typically requires knowledge of the initial vertical velocity and initial position/height.

Since in fall detection one aim is to detect a change in height, i.e. a difference between two positions in time, the integration can in fact be performed without knowledge of the value of the initial position, since it cancels in the difference equation. In addition, in fall detection, the initial vertical velocity is zero, provided the “initial” time moment is correctly chosen. In common daily situations, this can be any point before the onset of the fall. It will be noted, however, that any deviation from zero of the true, physical vertical velocity integrates over the chosen range to an error in the position/height estimation.

However, another problem in using double integration of an accelerometer signal concerns the proper separation of the acceleration due to gravity from the component of acceleration due to the motion of the user. To achieve a precision in height measurement of 10 cm over 1 second, the residual gravity component in the acceleration signal should stay within 0.2 ms⁻². Given that gravity is approximately 10 ms⁻², gravity needs to be separated with an accuracy of a few percent.

Since the orientation of the sensor unit is likely to be changing as the user falls, the direction of the vertical in terms of the coordinate system of the sensor unit will be changing as well. Here, the same problem arises. An error in the orientation estimation causes an error in the computation of the non-gravitational vertical component of acceleration. For the same reason, an error in the orientation also implies an error in the calculation of the corresponding gravity component. These errors mean that the true vertical acceleration is underestimated, while any horizontal acceleration that is present will ‘crosstalk’ into the estimate of the vertical acceleration. These errors manifest themselves in the vertical velocity estimate and therefore also in the estimated height (or change in height) of the device.

Furthermore, if the acceleration sensor is not properly calibrated, or has lost calibration over time, the sensed gravity will also change with the orientation of the sensor unit.

### SUMMARY OF THE INVENTION

In International patent application no. PCT/IB2012/054192 which was filed in the name of Koninklijke Philips Electronics N.V. on 17 Aug. 2012, a system and method is described that is able to overcome the above problems. The system and method makes use of two filters, one before the first integration step (i.e. when the accelerometer signal is integrated to obtain velocity) and one after, with at least one of the two filters being a non-linear filter. The filters are used to remove the component of acceleration due to gravity from the accelerometer signal prior to the integration, and to remove offset and drift from the outcome of the integration.

The use of one or two non-linear filters enables the reduction of transients that would otherwise result from using only linear filters in this process, and allows an estimation of absolute position (since the position value estimated using the process is constant before and after a position change, with the values differing by roughly the size of that position change).

However, when using only linear filters, although the position value estimated in the process will also be constant before and after the position change, their difference may be zero due to the transients, which means the actual change in position has been masked. This is illustrated in FIG. 1 for an accelerometer that is raised around 0.5 m (indicated by arrow 40) and then lowered by the same distance a short time later (indicated by arrow 42). Line 44 represents the output of the process when two moving average (linear) filters are used, and it can be seen that the effect of using these filters is that there is no sustained change in the position (i.e. height in this case) of the accelerometer (i.e. the estimated height before and after each actual change in height is around zero). In contrast, the use of at least one non-linear filter means that the change in height is apparent in the resulting height signal, which is labeled as line 46 in FIG. 1.

Since it can be sufficient to estimate or simply detect a position change rather than the absolute position of the device in many applications, such as detecting a height change in fall or physical activity detection, it is desirable for a method and apparatus or system to be provided that allows detection or estimation of a position change to be made even where the actual position change is masked within a position signal, for example when linear filters are used in the processing of an accelerometer signal.

Therefore, according to a first aspect of the invention, there is provided a method for determining the change in horizontal or vertical position of a device, the method comprising obtaining a signal that represents an estimate of the position of the device in a horizontal or vertical direction over time; identifying a maximum position value and a minimum position value from a selected portion of the signal representing the estimate of the position of the device; and determining the change in position over the selected portion of the signal as the difference between the identified maximum position value and the identified minimum position value. This method enables a change in position to be found even where the position change is masked within a position signal (although it can also be used to find the change in position in a signal where the position change is more easily visible or identifiable using conventional methods).

In preferred implementations, the maximum position value is the position value corresponding to a maximum in the signal and the minimum position value is the position value corresponding to a minimum in the signal. In alternative implementations, the maximum position value is an average of a plurality of the highest position values indicated in the signal and the minimum position value is an average of a plurality of the lowest position values indicated in the signal. In further alternative implementations, the minimum position value corresponds to a first rank value and the maximum position value corresponds to a second rank value, the first rank value and second rank value corresponding to the respective values at first rank order position and second rank order position after permuting the signal values in the selected portion of the signal in the order of increasing values, and where the first rank order position precedes the second rank order position. These alternative implementations enable the method to determine a change in position even where there are outlier values within the estimated position signal.

In some embodiments, the method further comprises the step of determining a time at which the determined change in position occurred. In these embodiments, the step of determining a time at which the determined change in position occurred can comprise determining the times at which the identified maximum position value and minimum position value occurred; and determining the time at which the determined change in position occurred as a time point between the times of the identified maximum position value and minimum position value.

In some implementations, the method further comprises the step of determining the temporal order in which the identified maximum position value and minimum position value occurred in the signal; and determining the direction of the determined position change based on the determined temporal order.

Where the signal represents an estimate of the height of the device, the step of determining the direction of the determined position change preferably comprises determining that the position change is a height increase if the identified minimum position value occurred before the identified maximum position value and determining that the position change is a height decrease if the identified minimum position value occurred after the identified maximum position value.

In alternative embodiments, the step of identifying a maximum position value and a minimum position value from a selected portion of the signal representing the estimate of the position of the device comprises identifying a maximum position value and a minimum position value to give a change in position of the device in a predefined direction, wherein the identified maximum position value and the identified minimum position value are the position values in the signal that have the largest difference, where the identified minimum position value and the identified maximum position value occur in a predefined temporal order in the signal. This embodiment (and the embodiments below) is useful when the invention is used to identify movement in a particular direction, for example height drops in the case of fall detection (followed by a height rise as the user of the device gets up), or height rises in the case of bed exit monitoring.

In a particular alternative embodiment, the step of identifying a maximum position value and a minimum position value from a selected portion of the signal representing the estimate of the position of the device comprises identifying a maximum position value and a minimum position value to give a change in position of the device in a first direction, wherein the identified maximum position value and the identified minimum position value are the position values in the signal that have the largest difference where the identified minimum position value occurs before the identified maximum position value in the signal.

In some implementations, the step of identifying a maximum position value and a minimum position value to give a change in position of the device in a first direction can comprise, for each local minimum in the selected portion, determining the difference in position between the value of the local minimum and the highest signal value occurring in the selected portion after the local minimum; and determining the minimum position value and the maximum position value to be the values of the local minimum and highest signal value pair having the largest difference.

Where the signal represents an estimate of the height of the device, the maximum position value and the minimum position value in the above implementation are identified such that they represent an increase in height.

In another particular alternative embodiment, the step of identifying a maximum position value and a minimum position value from a selected portion of the signal representing the estimate of the position of the device comprises identifying a maximum position value and a minimum position value to give a change in position of the device in a second direction, wherein the identified maximum position value and the identified minimum position value are the position values in the signal that have the largest difference where the identified minimum position value occurring after the identified maximum position value in the signal.

In some implementations, the step of identifying a maximum position value and a minimum position value to give a change in position of the device in a second direction comprises, for each local maximum in the selected portion, determining the difference in position between the value of the local maximum and the lowest signal value occurring in the selected portion after the local maximum; and determining the maximum position value and the minimum position value to be the values of the local maximum and lowest signal value pair having the largest difference.

Where the signal represents an estimate of the height of the device, the maximum position value and the minimum position value in the above implementation are identified such that they represent a decrease in height.

In some implementations, there is provided a method for determining the change in horizontal or vertical position of a device, comprising determining a change in position of the device in a first direction as described above; determining a change in position of the device in a second direction, that is opposite to the first direction, as described above; comparing the determined change in position in the first direction to the determined change in position in the second direction; if the determined change in position in the first direction is greater than the determined change in position in the second direction, determining whether the change in position in the second direction is an artifact of the signal, and if so, outputting the determined change in position in the first direction as the position change in the selected portion, otherwise outputting both the determined change in position in the first direction and the determined change in position in the second direction as position changes that occurred in the selected portion; and if the determined change in position in the first direction is less than the determined change in position in the second direction, determining whether the change in position in the first direction is an artifact of the signal, and if so, outputting the determined change in position in the second direction as the position change in the selected portion, otherwise outputting both the determined change in position in the first direction and the determined change in position in the second direction as position changes that occurred in the selected portion. This implementation is useful for determining whether there are multiple position change events in a particular selected portion of the signal, or whether one of the position change events is an artifact of the signal.

According to a second aspect of the invention, there is provided an apparatus, comprising processing means that is configured to obtain a signal that represents an estimate of the position of the device in a horizontal or vertical direction over time; identify a maximum position value and a minimum position value from a selected portion of the signal representing the estimate of the position of the device; and determine the change in position over the selected portion of the signal as the difference between the identified maximum position value and the identified minimum position value.

Various specific embodiments of the apparatus are also contemplated in which the processing means is configured to perform the steps contained in the above-described methods.

According to a third aspect of the invention, there is provided a device that is configured to be worn by a user, the device comprising an accelerometer that measures the acceleration acting on the device in three dimensions; and an apparatus as described above, wherein the processing means is configured to obtain the signal that represents the estimate of the position of the device over time using the measurements from the accelerometer.

According to a fourth aspect of the invention, there is provided a system, comprising a device that is configured to be worn by a user, the device comprising an accelerometer that measures the acceleration acting on the device in three-dimensions; and a base unit that is configured to communicate with the device, and that comprises an apparatus as described above, wherein the processing means is configured to obtain the signal that represents the estimate of the position of the device over time using the measurements from the accelerometer.

According to a fifth aspect of the invention, there is provided a computer program product, comprising a computer readable medium having computer program code embodied therein, the computer program code being configured such that, upon execution by a computer or processor, the computer or processor performs any of the methods described above.

### BRIEF DESCRIPTION OF THE DRAWINGS

Particular embodiments of the invention will now be described, by way of example only, with reference to the following drawings in which:

FIG. 1 is a graph illustrating the estimated absolute height obtained using linear and non-linear filters;

FIGS. 2(a) and (b) are block diagrams of a device and system in accordance with embodiments of the invention respectively;

FIG. 3 is a flow chart illustrating a method of detecting a change in height according to an embodiment of the invention;

FIG. 4 is a block diagram illustrating the processing of an accelerometer signal to determine a height change in accordance with an embodiment of the invention;

FIGS. 5(a) to 5(f) is a series of graphs showing the signals at various stages of processing to determine a height signal;

FIG. 6 is a graph illustrating a height signal obtained using the process shown in FIG. 4 using conventional linear filters and a height signal obtained from an air pressure sensor;

FIG. 7 is a graph illustrating the height change signals obtained from the height signals shown in FIG. 6;

FIG. 8 is a flow chart illustrating the operation of a first non-linear maxmin filter in accordance with an embodiment of the invention;

FIG. 9 is a series of graphs illustrating the height change estimated using the method shown in FIG. 8;

FIG. 10 is a flow chart illustrating the operation of a second non-linear maxmin filter in accordance with an alternative embodiment of the invention;

FIG. 11 is a graph illustrating the height change signal obtained using the non-linear filter illustrated in FIG. 10 on the height signal obtained using the process shown in FIG. 4 using conventional linear filters and a height change signal obtained from an air pressure sensor;

FIG. 12 is a flow chart illustrating the operation of a third non-linear maxmin filter in accordance with another alternative embodiment of the invention;

FIG. 13 is a flow chart illustrating an alternative way of operating the third non-linear maxmin filter in FIG. 12;

FIG. 14 is a graph illustrating the height change signal obtained using a ‘directed drop’ non-linear filter illustrated in FIG. 12 or 13 on the height signal obtained using the process shown in FIG. 4 using conventional linear filters and a height change signal obtained from an air pressure sensor;

FIG. 15 is a graph illustrating the height change signal obtained using a ‘directed rise’ non-linear filter illustrated in FIG. 12 or 13 on the height signal obtained using the process shown in FIG. 4 using conventional linear filters and a height change signal obtained from an air pressure sensor; and

FIG. 16 is a flow chart illustrating the operation of a fourth non-linear maxmin filter in accordance with yet another alternative embodiment of the invention.

### DETAILED DESCRIPTION OF PREFERRED EMBODIMENTS

The invention will be described below in terms of its use in an apparatus or device for detecting falls by a user (in which an accelerometer signal is integrated to obtain a signal estimating the height of the device worn by a user), but it will be appreciated that the invention can be used in other applications, such as in monitoring the physical activity of users (for example calculating the energy expended or power exerted during activity, or calculating the type of activity such as walking, sitting, lying, and standing) or monitoring the movement of other objects to which the apparatus or device can be attached. In these other types of devices, it may be useful to determine changes in horizontal displacement of the device, in addition to, or instead of, determining changes in vertical displacement (i.e. height). The description of the invention below is presented primarily in terms of the estimation of vertical components of acceleration and thus derives changes in height, but it will be appreciated by those skilled in the art that the described techniques can be used to determine the horizontal component of acceleration and thus a signal representing position along a horizontal axis, with the filters according to the invention determining whether there has been a change in the horizontal position from that position signal.

Furthermore, although in the fall detection application described below the changes in height of the device/user are estimated from acceleration measurements in order to determine if a fall has taken place, the estimated change in height of the device can also be used to determine whether the user is getting up after a fall (in which case a fall alarm can potentially be revoked), or the length of time that the user has been lying on the floor.

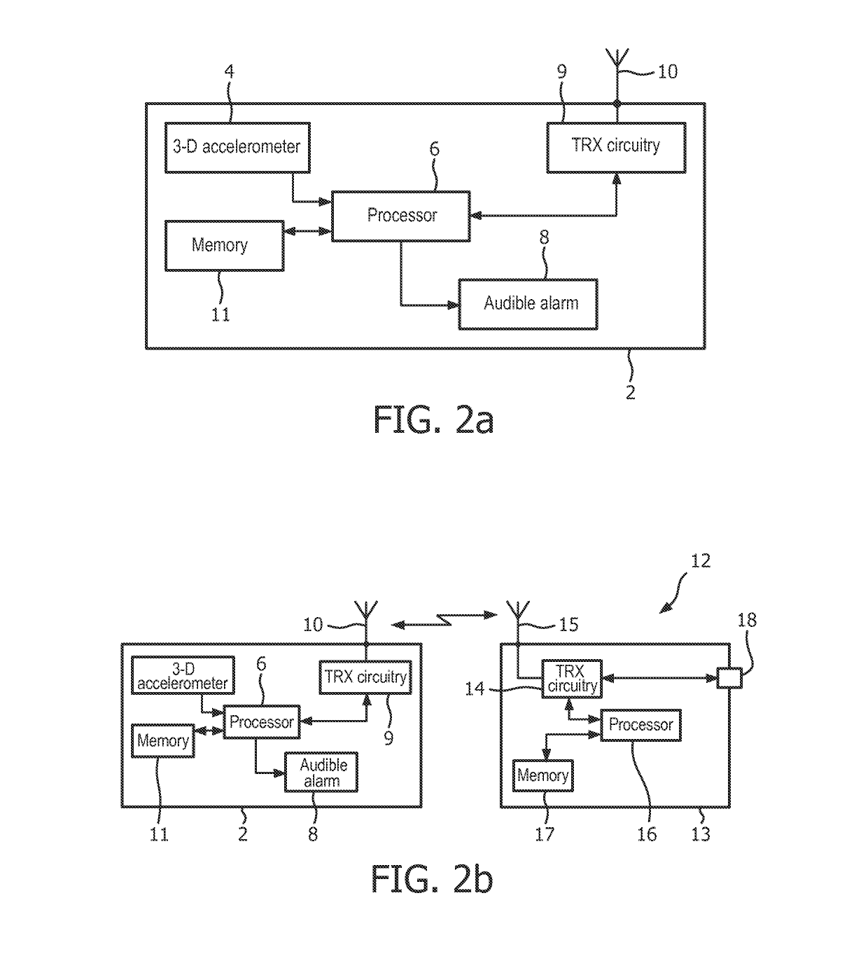

FIG. 2(a) illustrates an exemplary device 2 that implements a method of determining a change in height in accordance with the invention for the purpose of fall detection. The device 2 is in the form of a sensor unit that is to be worn by a user. The device 2 can be provided in the form of a pendant with a neck cord for placement around the user's neck, but alternatively the device 2 can be configured to be worn at or on a different part of the user's body, such as the wrist, waist, trunk, pelvis or sternum, and will comprise a suitable arrangement for attaching the device 2 to that part of the body (for example a belt or a strap). The device 2 can alternatively be provided in the form of a mobile communication device or any other type of wearable or portable electronic device, such as a mobile telephone, personal digital assistant (PDA), tablet computer, satellite navigation device or smartphone.

The device 2 is used to measure the accelerations experienced by the user and to process the measurements to determine the height of the device 2, and then to detect whether there has been a change in height of the device 2 (and hence the change in height of the user). Although not described herein, it will be appreciated that a device 2 may perform additional processing on the acceleration measurements to identify other characteristics of a fall, such as an impact or a period of immobility following an impact. It will also be appreciated that the device 2 may contain further sensors, such as a gyroscope, magnetometer, air pressure sensor and/or air flow sensor, whose signals can be processed to determine, or to assist in determining, height, orientation or other characteristics associated with a fall.

The device 2 comprises an accelerometer 4 that measures acceleration along three orthogonal axes. The signals output by the accelerometer 4 are provided to a processor 6 for analysis. As illustrated, the device 2 comprises an audible alarm unit 8 that can be triggered by the processor 6 if a fall is detected. This alarm can summon help to the user. However, it will be appreciated that the presence of an audible alarm unit in the device 2 is optional. A further optional component is a help button that can be pressed by a user to summon help.

The device 2 further comprises transmitter or transceiver circuitry 9 and associated antenna 10 that can be used for transmitting the results of the processing to a remote (base) unit or for placing an emergency call to a call center to summon help in the event that a fall is detected or in the event that a help button (if present) has been pressed. The device 2 also optionally comprises a memory 11 that is used for storing measurements from the accelerometer 4, and for storing the results of the processing by the processor 6.

In some embodiments, the accelerometer 4 is a micro-electromechanical system (MEMS) accelerometer.

The acceleration experienced by the accelerometer 4 can be sampled at a rate of 30 Hz, although it will be appreciated that many other sampling frequencies can be used (for example 50 Hz).

In an alternative embodiment of the invention, as illustrated in FIG. 2(b), the device 2 is part of a system 12 in which the processing of the accelerometer measurements can be performed in a base unit 13 that is separate to the device 2 worn by the user. In that case, the accelerometer measurements can be transmitted from the device/sensor unit 2 to the base unit 13 via the transceiver circuitry 9.

The base unit 13 comprises transceiver circuitry 14 and antenna 15 for receiving transmissions (such as the accelerometer measurements) from the device 2 and a processor 16 for processing the measurements according to the invention.

The base unit 13 also optionally comprises a memory 17 that is used for storing accelerometer measurements received from the device 2, and for storing the results of the processing by the processor 16.

The transceiver circuitry 14 may be configured for wirelessly placing an emergency call to a call center, and/or may be configured for connection to a conventional PSTN line via port 18.

In a further alternative, the device 2 may perform some of the initial processing steps on the accelerometer measurements before transmitting the results to the base unit 13 which, for example, completes the processing and estimates the change in height of the device 2.

It will be appreciated that only components of the device 2 (and system 12) that are required for explaining the invention have been illustrated in FIGS. 2(a) and (b), and a device 2 (or system 12) according to the invention may include further components and functionality to those described herein. For example, it will be appreciated that a device 2 (and base unit 13) will include some form of power source or supply and circuitry for controlling the operation of the device 2 (and base unit 13).

The following description of the invention refers to the device 2 shown in FIG. 2(a), but it will be readily appreciated by those skilled in the art how the invention can be adapted for use in the system 12 shown in FIG. 2(b).

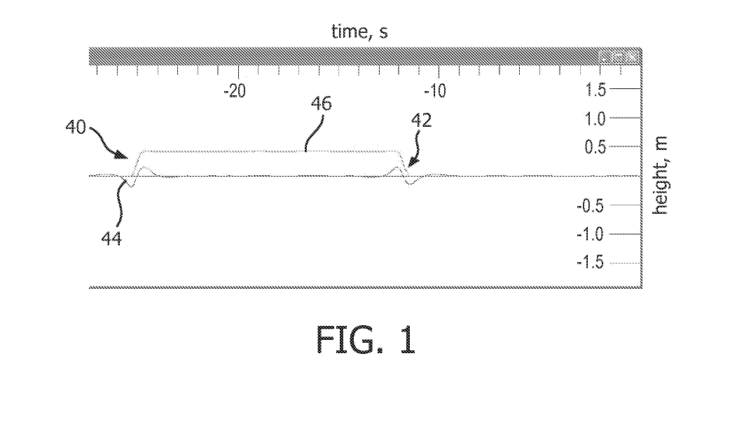

In a first step of the method, step 101, an estimate of the vertical or horizontal position of the device 2 (and thus the user or object to which the device 2 is attached to or carried by) over time is obtained. Lines 44 and 46 in FIG. 1 are examples of estimates of the vertical position (height) of the device 2 over time obtained in step 101.

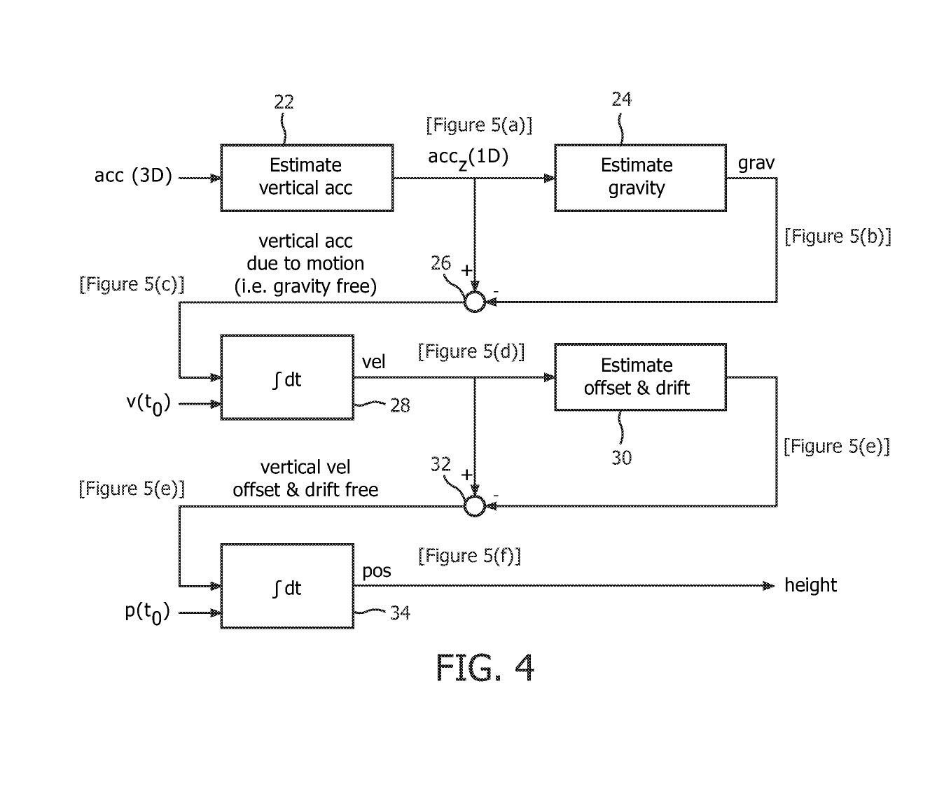

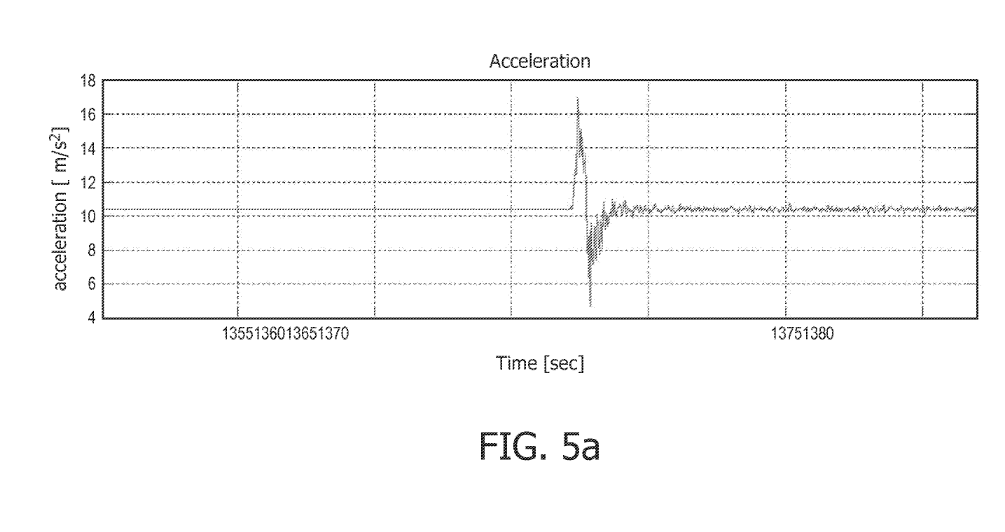

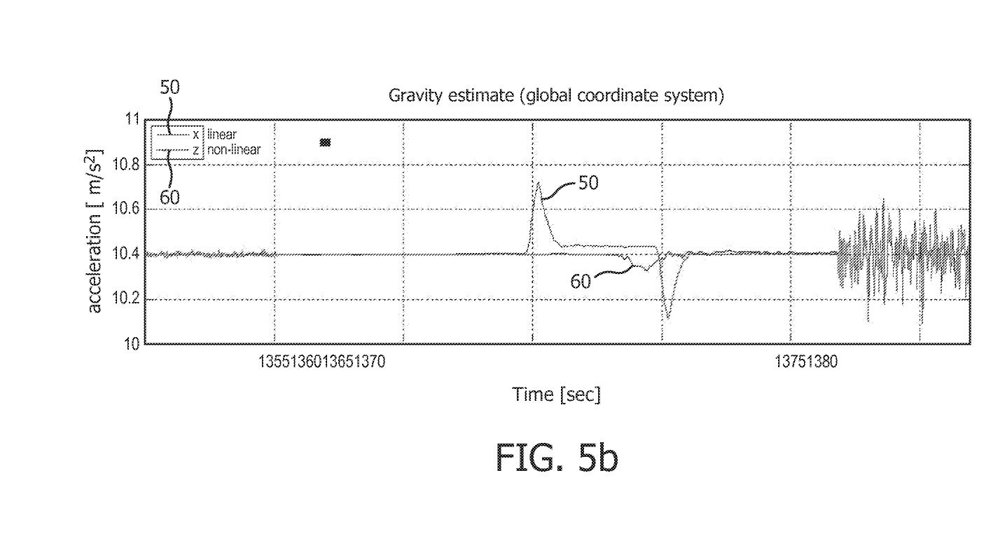

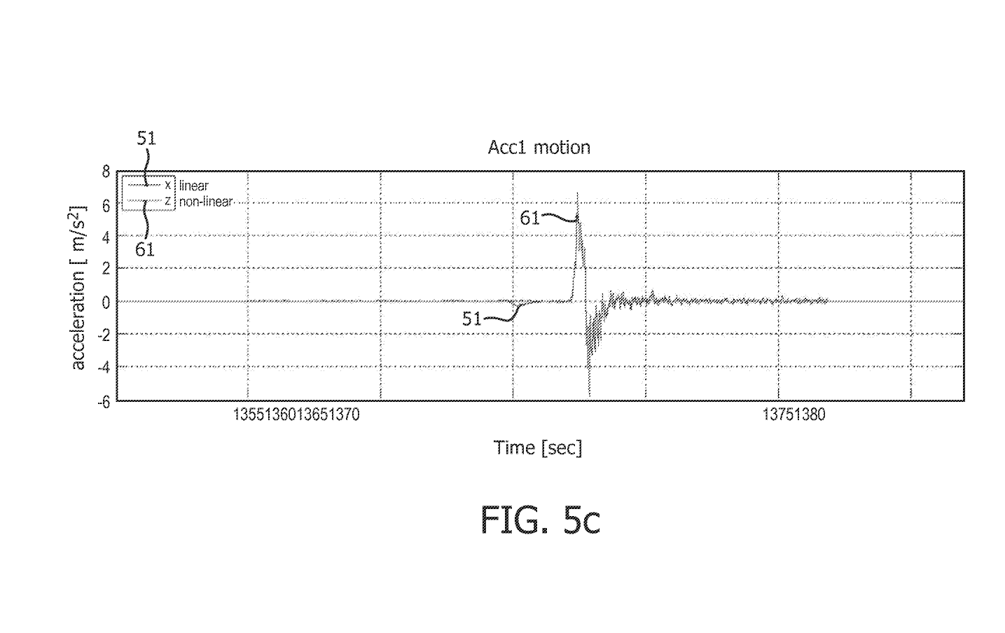

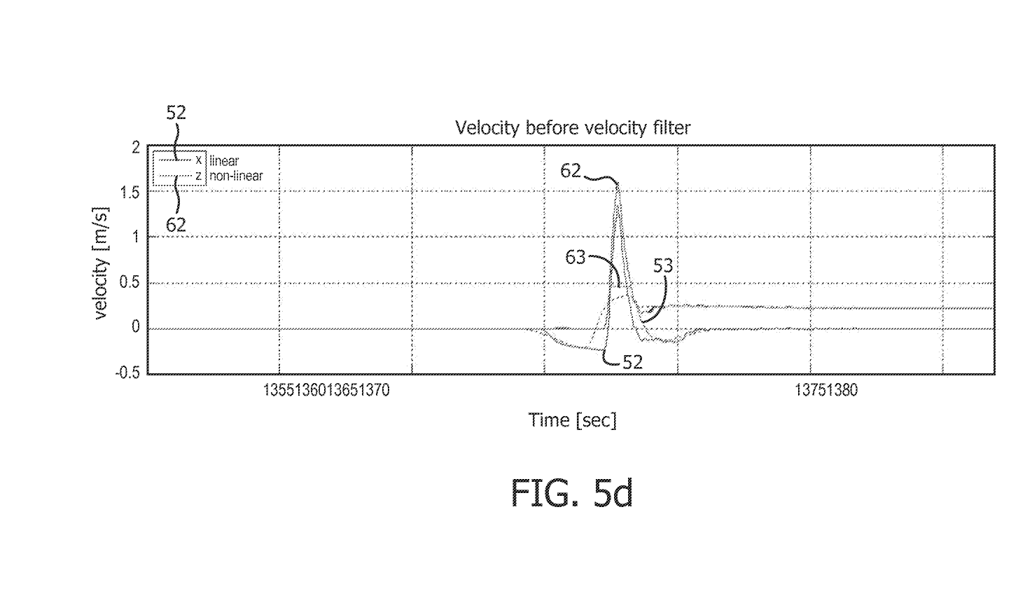

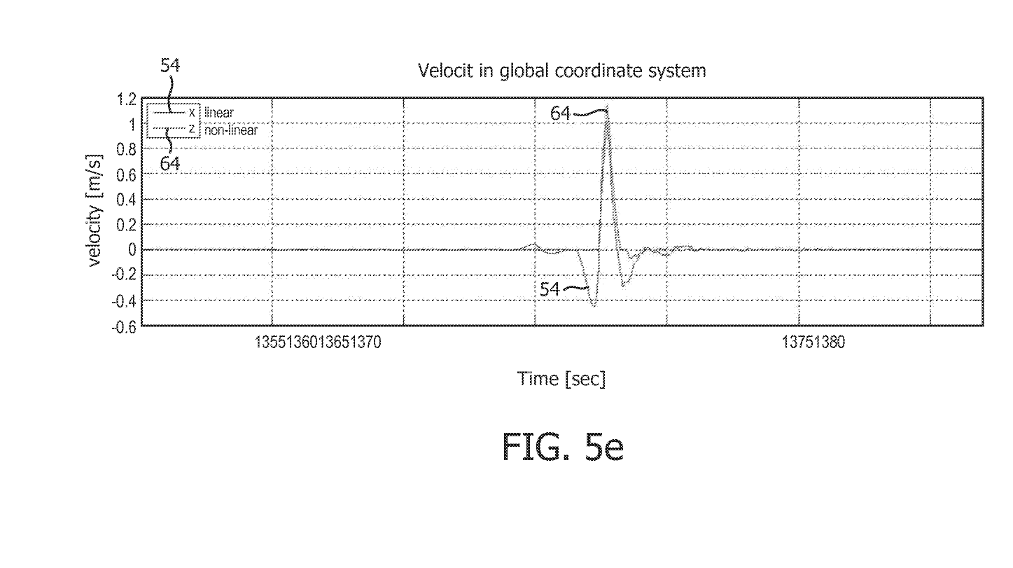

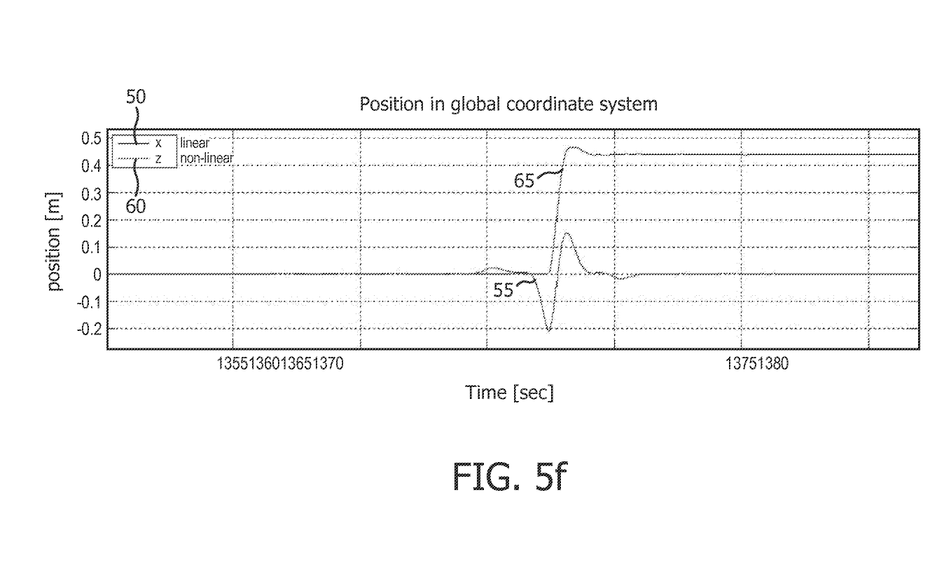

As described in more detail below with reference to FIGS. 4 and 5, step 101 can comprise measuring the acceleration of the device 2 over time using the 3-D accelerometer 4, and filtering and integrating the acceleration measurements to provide a signal representing an estimate of the vertical or horizontal position of the device 2.

In some embodiments, additional sensors (such as an air pressure sensor, gyroscope and/or magnetometer) are used to provide further information on the position and/or orientation of the device 2 which is processed along with the acceleration measurements to determine the signal representing the estimate of the vertical or horizontal position of the device 2 over time. In alternative embodiments, step 101 can comprise measuring the height of the device 2 over time using another type or types of sensor, such as an air pressure sensor, whose output can be converted into an estimate of the position of the device 2 (e.g. height or altitude in the case of an air pressure sensor).

FIG. 4 is a block diagram illustrating an exemplary way in which measurements from accelerometer 4 can be processed in order to obtain an estimate of the vertical or horizontal position of the device 2 over time. Those skilled in the art will be aware of other ways in which a position signal for use in the present invention can be obtained.

Briefly, in some embodiments, step 101 can comprise obtaining measurements of the acceleration acting in a vertical or horizontal direction on the device 2 using the accelerometer 4, using a first filter to remove acceleration due to gravity from the obtained measurements to give an estimate of the acceleration acting in a vertical or horizontal direction due to motion of the device 2, integrating the estimate of the acceleration acting in a vertical or horizontal direction due to motion of the device to give an estimate of vertical or horizontal velocity and using a second filter to remove offset and/or drift from the vertical or horizontal velocity to give a filtered vertical or horizontal velocity. The first filter can be a linear or non-linear filter, and the second filter can be a linear or non-linear filter. In some cases, the second filter can be omitted.

FIGS. 5(a)-(f) are graphs illustrating the signals at various stages of the processing shown in FIG. 4 for an implementation in which each of the first and second filters are linear and an implementation in which each of the first and second filters are non-linear.

It will be appreciated by those skilled in the art that the processing block shown in FIG. 4 can be implemented within the processor 6 of the device 2 or as separate electronic components.

As an initial step, a series of measurements of the acceleration acting on the accelerometer 4 (and therefore device 2) are collected. As indicated above, the accelerometer 4 measures acceleration in three dimensions and outputs a respective signal for each of the measurement axes.

The accelerometer measurements are provided to a first processing block 22 that processes the measurements to identify the component of acceleration acting in the vertical direction. This processing can be performed in a number of different ways.

For an accurate estimation of the vertical acceleration to made, it is desirable to obtain an accurate estimation of the orientation of the accelerometer 4 (and therefore device 2) so that a coordinate transformation (rotation) can be applied to the accelerometer measurements.

This orientation estimation can be obtained when the device 2 comprises a further sensor, such as a gyroscope and/or magnetometer, and the output from these sensors, possibly together with that from the accelerometer 4, is used to determine the coordinate transformation (rotation) to be applied to the accelerometer measurements. Alternatively, the device 2 can comprise multiple accelerometers, and the orientation can be estimated from the different accelerations sensed at the respective locations of the accelerometers. After coordinate transformation, the vertical component of acceleration can easily be identified.

Alternatively, acceleration due to gravity (which by definition acts in the vertical direction) can be estimated as the low-pass component of the accelerometer measurements (making sure that the magnitude of the low-pass component is constant), and the direction that this component acts can be used to determine the (vertical) orientation of the accelerometer 4. The acceleration in the direction of the low-pass filtered acceleration will correspond to the acceleration in the vertical direction. As a yet further alternative, the output of a process that is similar to that performed by processing block 24 when using a non-linear filter described below can be used to obtain an estimate of gravity and hence its direction (it is similar in the sense that it now operates on each of the components of the three-dimensional accelerometer signal).

A simpler way to estimate the vertical component of acceleration is to compute the norm of the 3D acceleration measurements. The signals output for each of the three measurement axes include gravity, which points in the vertical direction, and can be assumed to have a relatively large magnitude relative to accelerations due to motion. The accelerations due to motion and due to gravity combine as a vector sum. When computing the norm of this vector sum the contribution of the horizontal components are relatively small, since they are orthogonal to the gravity component and small in magnitude compared to this gravity component. Accelerations in the vertical direction will appear in the norm with an unaltered magnitude, provided that, when they are in a downward direction, they do not exceed gravity (otherwise the norm will turn the net negative component into a positive one, where an upward acceleration, such as by gravity alone, is defined positive). So, the norm is a cost-effective estimator of the vertical acceleration (including gravity). However, as suggested above, significant horizontal accelerations and large downward accelerations (i.e. exceeding gravity) will introduce distortions in the estimated vertical acceleration.

If the device 2 is implemented as, for example, a pendant to be worn around a user's neck, the device 2 will typically be in one particular orientation, and knowledge of this orientation can be used to identify the vertical component of acceleration from the accelerometer measurements. However, it will be appreciated that this approach is potentially subject to large errors if the device 2 is not worn properly or if its orientation changes during normal use or during a fall.

Another approach is described in WO 2010/035191 which describes a technique for estimating the vertical component of acceleration from a 3D accelerometer signal having an arbitrary orientation. According to that technique, the vertical component of acceleration is estimated by (i) examining the signals from the accelerometer to identify the axis of the accelerometer having the highest component of acceleration, (ii) determining the orientation of the accelerometer by determining the angle between the acceleration acting on the accelerometer (this acceleration being assumed to be generally due to gravity) and the axis with the highest component of acceleration and (iii) using the estimated orientation of the accelerometer to determine the acceleration in the vertical direction from the measurements of acceleration.

The vertical component of acceleration output by the first processing block 22 is denoted acc_{z} in FIG. 4, and an exemplary vertical component signal is shown in FIG. 5(a). This signal covers a period of time in which an increase in height occurs (around time 1368 seconds); where the device has been lifted from a stationary position on a desk and held in the hand, which induces some vibration. The vertical component of acceleration is provided to a second processing block 24 and to an addition/subtraction block 26.

Processing block 24 estimates the acceleration due to gravity in the vertical component of acceleration using a first filter.

In a simple embodiment, processing block 24 uses a constant value for gravity. This value may be 9.81 ms⁻², but it may be a different value, depending on the particular characteristics or calibration of the accelerometer 4. For example, it is not uncommon for an accelerometer 4 to output values for acceleration that are out from the actual values by 0.2 mS⁻² or more, and this can be factored in to the constant value used. This can be seen in FIG. 5(a) where the constant value is greater than 10 ms⁻². In this simple embodiment, processing block 24 can apply an estimator to the vertical component of acceleration that outputs a constant value for gravity (e.g. 9.81 ms²). As known, apart from the constant output, the estimator can be understood to be a filter.

In an alternative embodiment, processing block 24 can apply a linear filter to the vertical component of acceleration to provide the estimate for gravity. The linear filter can be a low-pass filter with an appropriate cut-off frequency. For example, the filter can be a moving average (MA) filter.

As known, a linear filter is characterized by its impulse response curve. A pulse at its input results in a signal that is spread in time. Therefore, a sudden change in acceleration, which happens during a fall, can be seen as a pulse superimposed on the continuously sensed gravity signal. Consequently, when estimating a gravitational component using a linear filter, there will be an over and under estimation due to the impulse spread. The severity of the over or under estimation depends on the bandwidth of the filter (or length of the impulse response). These over and under estimations will be treated in the subsequent integration step as part of the vertical acceleration due to motion and hence will lead to an erroneous velocity estimate, and thus position estimate too.

Furthermore, the component of gravity along each of the measurement axes of the accelerometer 4 changes when the orientation of the accelerometer 4 changes. This change appears as a transient error in the estimated gravity. The transient error is similar to the impulse response and has the same spread (more precisely, it is a step response). This spread also results in an error in the velocity and position estimate after the integration steps. This type of error is not present in the embodiment where the norm is used, assuming no calibration error, since the norm is insensitive of orientation.

Where the vertical component of acceleration is estimated (as in the process described above), this orientation change is taken into account, and the effect is reduced to the level of errors in the orientation estimated by block 22. In the event that the measurements from the accelerometer 4 include an offset the change in orientation will cause a change in magnitude of the sensed gravity component due to that offset. This is another effect that can cause transient errors, which again may appear as errors in the height estimate.

As described in International patent application no. PCT/IB2012/054192, processing block 24 can apply a non-linear filter to the vertical component of acceleration to provide an estimate for gravity. The non-linear filter is much more capable of “ignoring” the sudden change in acceleration that occurs during a fall, or of following the transient that occurs upon a change in orientation.

This non-linear filter can be a median filter. As known, a median filter processes each sample in the input signal in turn, replacing each sample with the median of a number of neighboring samples. The number of samples considered at each stage is determined by the window size of the filter. A typical half window size can be 1.6 seconds (so the window encompasses 1.6 seconds worth of samples before the current sample and 1.6 seconds worth of samples after the current sample).

A median filter is known for suppressing pepper-and-salt noise in video images, i.e. suppressing (black-and-white) signal spikes of short duration. The accelerations experienced during a fall can be considered as a spike in the acceleration signal of (relatively) short duration, and therefore removing this spike using a median filter will therefore produce a much better estimate of gravity, and does not suffer from the response spread problems associated with linear filters.

The non-linear filter could alternatively be a recursive median filter. This type of filter has the property that it tends to stick to its previous estimates (of gravity). In this way, a fluctuation in the acceleration does not immediately appear as crosstalk in the estimate of the gravity component, while a change, e.g. a step due to an orientation change and poor calibration of the accelerometer 4, is still followed.

As known, a recursive median filter is similar to a median filter, except that in computing the median for a particular sample it uses the already-computed median values in the sample window, rather than the original sample values in the signal.

The recursive median filter can be a forward or backward recursive median filter, which determines the direction in which the vertical acceleration signal is filtered. The forward recursive median filter will try to keep the past values (i.e. keep them constant), while the backwards recursive median will try to keep the future values. Depending on the nature of the signal, the output of each of these types of recursive median filter can be different. For example, where the signal before a pulse has a lower value than after the pulse, a forward recursive median filter will tend to use the lower value, while the backwards recursive median filter will tend to use the higher value, and there will be a difference between the two outputs. Thus, it is possible to apply both filters separately to the vertical acceleration signal and average the results to obtain the gravity component. Alternatively linear interpolation between the points where the two filter outputs diverge can be used. It is possible to combine the two results in different ways.

The non-linear filter could alternatively be a weighted median filter, in which a respective weight is applied to each sample in the filter window, or a mode filter which takes the sample value to which most of the sample values in the current window are closest.

In other cases, hybrid versions can be used to filter the vertical acceleration. This filter can estimate gravity and a decision process run to decide what value to use. This decision can be to use a combination of estimates by different filters or to freeze the estimated gravity when the level of motion exceeds a threshold, for example.

FIG. 5(b) shows the estimate of the acceleration due to gravity output by processing block 24 when a linear low-pass (moving average) filter is applied to the vertical acceleration signal (represented by line 50) and when a non-linear median filter is applied to the vertical acceleration signal (represented by line 60).

Although not illustrated in FIG. 4, it is possible to apply a further filter to the estimate of the gravitational acceleration to smooth the signal.

Where the device 2 is also configured to process the accelerometer measurements to determine if the user is getting up following a detected fall, it is possible to time-shift the estimated acceleration due to gravity by one or two seconds. When the user is lying on the floor, the signal for the gravitational component is relatively smooth (i.e. constant). Therefore, by time-shifting the gravitational estimate, a constant value can be used during the period where the user might be getting up.

The estimate of the acceleration due to gravity output by processing block 24 is provided to the addition/subtraction block 26 where it is subtracted from the vertical component of acceleration output by the first processing block 22 to leave the acceleration in the vertical direction due to the motion of the device 2. The estimated vertical acceleration due to motion output by block 26 (after subtracting the gravity estimate obtained using a moving average filter—labeled 51, and after subtracting the gravity estimate obtained using the non-linear median filter—labeled 61) is shown in FIG. 5(c).

It will be appreciated that the output of processing block 24 may be delayed with respect to the estimate of vertical acceleration provided directly to the addition/subtraction block 26 due to the time required for the processing by processing block 24. Therefore, the inputs to block 26 can be synchronized (for example by introducing a delay into the vertical acceleration estimate, acc_{z}).

It will also be appreciated that the non-linear median filter 24 that is applied to the vertical acceleration signal and the subsequent addition/subtraction block 26 can be replaced by a single filter, referred to herein as a ‘complementary’ median filter, which acts in the opposite way to the median filter, i.e. it passes the parts of the signal blocked by the median filter and blocks the parts of the signal passed by the median filter. Thus, the ‘complementary’ median filter passes the pulses of short duration representing the vertical acceleration due to motion of the device 2 and removes the gravitational acceleration in the vertical acceleration signal. A similar ‘complementary’ moving average filter could be provided in the embodiments in which the filter 24 is a linear filter.

The signal representing the vertical acceleration due to the motion of the device 2 is then integrated with respect to time by processing block 28 to give an estimate of the velocity in the vertical direction. The initial velocity value v(t₀) input to the integration block 28 is unknown, but is typically assumed to be zero. In any case, the next filtering stage (described further below), and which may be omitted as noted above, removes offset and drift in the vertical velocity signal, and therefore the initial velocity component (if non-zero) will be substantially removed.

It has been found that the gravity-free acceleration signal (shown in FIG. 5(c)), is not a perfect representation of the accelerations due to the physical movement of the device 2. The signal is distorted, effectively causing an additional velocity component in the output of the integration block 28. The distortion can be caused by the orientation estimation process performed by processing block 22 and also by horizontal accelerations that cross-talk into the vertical estimate. In particular, when using a norm as an estimator, there will be crosstalk. Also, that crosstalk will have a positive sign (i.e. always increasing the value of the vertical component) hence a step in the velocity component is usually positive, as shown in line 62 of FIG. 5(d) after the pulse. The distortion is not constant, but relates to the movement signal, and therefore cannot be filtered as part of the gravity estimation by processing block 24. However, after the integration by block 28, the distortion primarily causes a monotonous component. This can be seen, for example, in the line labeled 62 in FIG. 5(d) where the integration has left an offset of about 0.25 ms⁻¹ in the velocity. If a linear filter is used at the gravity estimation stage, the errors in the estimated gravity due to the filter response spread cause significant velocity components (shown in the line labeled 52 in FIG. 5(d)).

Therefore, the signal representing the vertical velocity is provided to a fourth processing block 30 which applies a filter to the vertical velocity signal to estimate the offset and any drift components present in that signal. The result of this filtering is a signal representing the fluctuations of the monotonous (i.e. offset and drift) component.

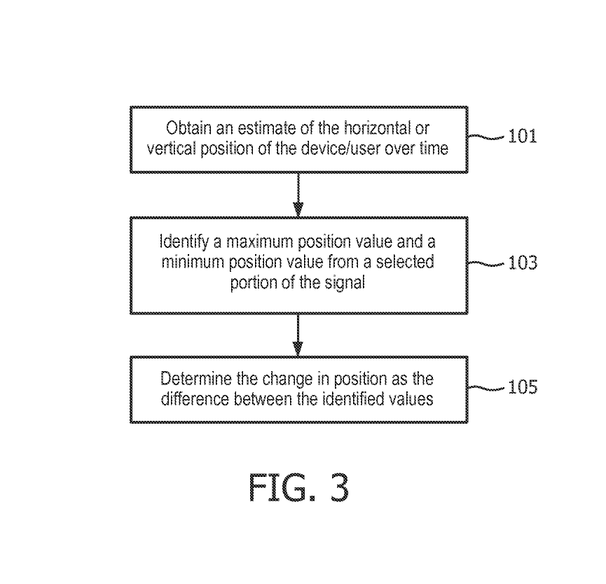

Traditional linear filters to obtain a DC (constant) or slowly changing (offset and drift) component include low-pass filter and moving average filters (which also exhibits low pass behavior). These filters affect adjacent samples through the time response corresponding to the filter. So, while an offset may be removed, a compensating “ghost offset” may appear before and after the corrected stretch of samples. These “ghost offsets” can significantly obscure the result of integrating the corrected stretch of samples to obtain a change in height. However, the non-linear filter used in step 103 of FIG. 3 allows the change in height to be extracted from the height signal.

Alternatively to the use of linear filters, a non-linear filter can be applied by the processing block 30 to the vertical velocity signal to remove the offset and drift present in the signal. This non-linear filter might be a median filter. As described above, the median filter effectively blocks pulses and oscillations in a signal while passing constant and edges (i.e. the offset and drift). A typical half window size for this filter can be 0.8 seconds (so the window encompasses 0.8 seconds worth of samples before the current sample and 0.8 seconds worth of samples after the current sample). As with the first filter above, where the second filter is a non-linear filter, the filter may alternatively be a weighted median filter or a mode filter.

Where the filter applied by processing block 24 is a non-linear filter, the fourth processing block 30 can apply a linear filter to the vertical velocity signal to estimate the offset and drift, depending on the application that uses the resulting velocity or height estimate. As can be seen in FIG. 5(d), the application of the non-linear filter in processing block 24 has limited the spread in the obtained velocity. The application of a linear filter to remove the offset and drift will cause some spread, but it may be of an acceptably limited extent.

The signal representing offset and drift in the vertical velocity signal that is obtained using a linear moving average filter and that includes a ‘ghost offset’ as described above, is shown as dotted line 53 in FIG. 5(d). The signal representing the offset and drift in the vertical velocity signal that is obtained using a non-linear median filter and that is output of the processing block 30 is shown as dotted line 63 in FIG. 5(d).

The signal from processing block 30 is input to an addition/subtraction block 32 along with the vertical velocity signal from integration block 28, where it is subtracted from the vertical velocity signal to give an offset and drift free vertical velocity signal. The vertical velocity obtained through the application of a linear moving average filter to the estimate of vertical velocity is shown by line 54 in FIG. 5(e), and it can be seen that part of the spread in the velocity has been removed, but a significant reversed component remains near the peak. The vertical velocity obtained through use of non-linear median filters is shown by line 64 in FIG. 5(e), and it can be seen that the non-linear filters applied during the earlier processing stages result in a more accurate estimate of the actual vertical velocity of the device 2.

As with addition/subtraction block 26, the inputs to addition/subtraction block 32 may need to be synchronized to compensate for the delay introduced by processing block 30.

As with the filtering in processing step 24, it will be appreciated that the non-linear median filter 30 that is applied to the vertical velocity signal and the subsequent addition/subtraction block 32 can be replaced by single filter, referred to herein as a ‘complementary’ median filter, which acts in the opposite way to the median filter, i.e. it passes the parts of the signal blocked by the median filter and blocks the parts of the signal passed by the median filter. Thus, the ‘complementary’ median filter passes the pulses of short duration representing the actual velocity of the device 2 and removes the offset and drift present in the vertical velocity signal. As above, a similar ‘complementary’ moving average filter could be provided in the embodiments in which the filter 30 part is a linear filter.

The offset and drift free vertical velocity signal is then integrated with respect to time by processing block 34 to give a signal estimating the height of the device 2. The initial position value p(t₀) input to the integration block 34 will typically be unknown, but where the result of the integration is used to determine a change in the height, knowledge of the initial position is unnecessary. If it is desired to calculate the actual height, some calibration or initiation will be required in order to set p(t₀).

FIG. 5(f) shows the estimated height signal when linear filters are used during the processing (line 55) and when non-linear filters are used during the processing (line 65). It will be noted that FIG. 5(f) shows signals that are similar to those found in the left hand side of FIG. 1. It can be seen from line 65 that a ‘sustained’ increase in height has occurred, but the transients introduced into the signal obtained using linear filters result in the height change being masked in that signal (line 55).

As described above with reference to FIG. 4, the acceleration acting in a vertical direction is estimated from the three-dimensional accelerometer measurements (for example by taking the norm of the accelerometer measurements) and then the filter is applied to the one-dimensional vertical acceleration estimate in order to estimate the acceleration due to gravity. In an alternative implementation, the first filter can be applied to the signals from each of the measurement axes of the accelerometer 4 in order to estimate the acceleration due to gravity in three dimensions, prior to the estimation of the vertical component of acceleration. This three-dimensional gravity estimate can then be used to estimate the vertical component of acceleration in the three-dimensional accelerometer measurements, whereafter the gravity estimate (or another gravity estimate obtained using a further filter—the same or a different type to the first filter) is subtracted from the estimated vertical component to give the estimated vertical acceleration due to the motion of the device. In addition, using this approach the horizontal accelerations (due to motion) can be estimated and be processed in a similar manner to estimate horizontal velocity and position.

Returning now to FIG. 3, once the height signal has been obtained in step 101, a filter is applied to the estimate of the height of the device 2 to detect if there has been a change in height of the device 2. In some embodiments, the output of the filter can be an indication of whether there has been a change in height that is greater than a predetermined amount. In other embodiments, the output of the filter can be an indication of the actual change in height (and whether the change was an increase in height or a decrease in height).

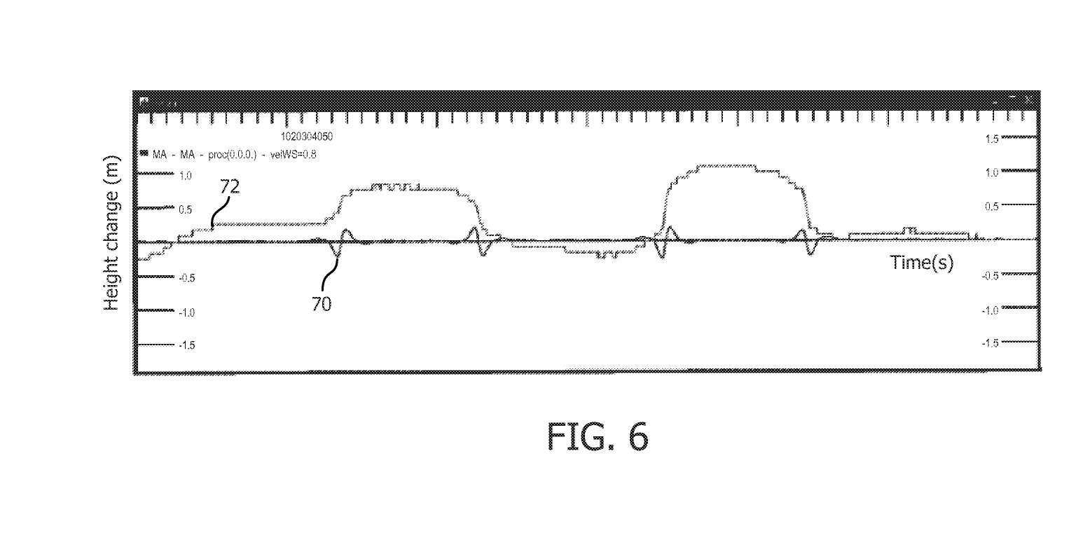

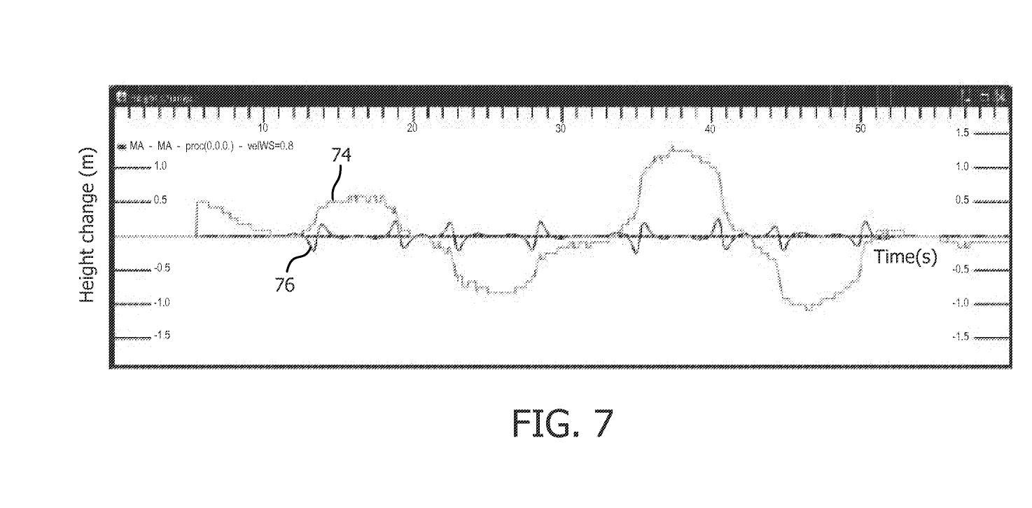

Conventionally, a change in height is detected and estimated by computing the difference between the height estimate at a particular (current) sample in the signal and an earlier sample that is a predetermined time period before the current sample. This way of detecting and computing a change in height corresponds to the application of a linear filter. However, as discussed above, this type of filtering is unable to detect a change in height in height signals such line 44 shown in FIG. 1 where the transients in the height signal mask the actual height change. This problem is illustrated in FIGS. 6 and 7. FIG. 6 shows a height signal 70 (which is similar to signal 44 shown in FIG. 1) that is obtained from accelerometer measurements using the process illustrated in FIG. 4 with filter 24 and filter 30 being linear filters. FIG. 6 also shows a height signal 72 that is obtained in a conventional manner from an air pressure sensor, and it can be seen that there are two events in which the device 2 is raised and then lowered, although the height signal 70 shows no overall change in the height of the device 2.

FIG. 7 shows a height change signal 74 derived from height signal 72 in FIG. 6, and a height change signal 76 derived from height signal 70 in FIG. 6. In both cases, the height change signals 74, 76 are obtained using a linear filter that is passed over height signal 72, 70 respectively in FIG. 6. In this example, the linear filter calculates the difference between the current height estimate and the height estimate 5.5 seconds earlier in the height signal. Thus, it can be seen in signal 76 that although the described filter operation will give both decreases and increases, it is not easy to identify what height changes have occurred. In particular in real-life situations, where the height signal will continuously be varying, it will be difficult to determine from all the resulting decreases and increases what the true (physical) height is, if any change happened at all.

Thus, in accordance with the invention, the filter applied to the estimated position signal is a non-linear filter as this allows position changes to be detected (and quantified) in position signals even where the position change is masked by the transients in the signal. In preferred embodiments, the non-linear filter is a ‘maxmin’-based filter which is discussed in more detail below.

Briefly, the filter identifies a maximum position value and a minimum position value from a windowed portion of the signal (step 103 in FIG. 3) and determines the change in position as the difference between the identified values (step 105). As described in more detail below, the identified maximum position value and the minimum position value are the outcome of a function that operates on the estimated position signal, where the outcome value associates with some central point in the largest and smallest position values. In some embodiments, the maximum position value and minimum position value may be the global maximum and minimum signal values in the windowed portion, they may be global and/or local maximum and minimum signal values in the windowed portion identified according to specific rules, they may be an average of a plurality of the highest and lowest signal values respectively or they may be the signal value in a particular rank position in the windowed portion. Other forms of obtaining a central point representing the maximum and minimum value can be used as well. The two forms are not required to be identical.

The various non-linear filters proposed herein exploit the fact that the position change itself is still visible in the position signal obtained using two linear filters. As can be seen in line 44 of FIG. 1 and in line 55 of FIG. 5(f), the actual height rise is represented in the signal, but it is preceded and followed by an apparent height decrease (also referred herein as a drop). Likewise, an actual height drop is preceded and followed by a height rise. As noted above, these artifacts arise from the transients of the linear filters applied in the derivation of the position signal.

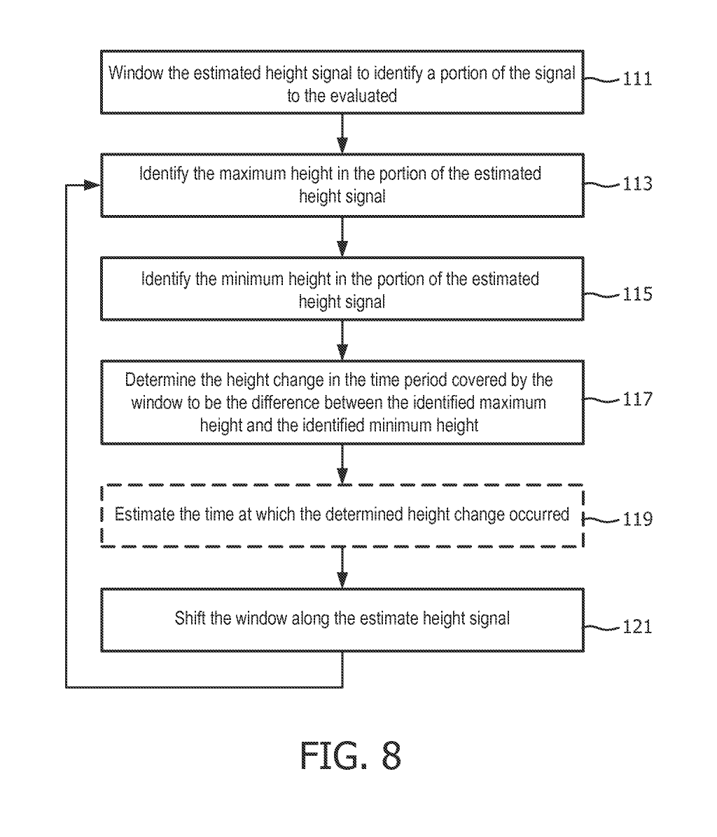

The operation of a first non-linear filter for use in step 103 that can be used to detect if there has been a change in position (height hereafter) or to output the particular change in height that has occurred is illustrated in FIG. 8. This first preferred type of non-linear filter is referred to as a ‘maxmin’ filter herein.

The principle of the maxmin filter is to define a window on the height signal of a predefined size, denoted diffSz, and to compute the difference between the maximum height and minimum height that occur in that window. The difference between the maximum height and minimum height is the estimate of the height change over the time period covered by the window.

Thus, in a first step of FIG. 8, step 111, a window is applied to the height signal to select the portion of the height signal for analysis by the filter.

In step 113, the maximum height that occurs in the selected portion is identified. In other words, the sample in the height signal within the window with the highest value is identified.

One way of identifying the maximum height in step 113 is to (i) store the value of the first sample in the selected portion as a parameter maxT, (ii) take the next sample in the selected portion and compare the value of that sample with the stored value of maxT, (iii) if the new value is larger, store the new value as maxT, otherwise maintain the value of maxT at its current value, and (iv) repeat from step (ii). Pseudo code corresponding to this process is set out below:

int k0= index of first sample in selected portion
int k1= index of last sample in selected portion
double maxT= sig[k0];
for (int k=k0;k<=k1;k++) if (sig[k]>maxT) maxT= sig[k];
return maxT;

Likewise, the minimum height (i.e. sample with the lowest value) that occurs in the selected portion is identified (step 115). It will be appreciated that although the identification of the maximum height and minimum height are shown as separate sequential steps in FIG. 8, the processor 6 will typically analyze each sample in the window in turn and seek to identify the maximum height and minimum height in a single pass over the data.

Once the maximum height and minimum height have been identified, the processor 6 determines the height change in the time period covered by the window to be the difference between the maximum height and the identified minimum height (step 117). This step can comprise a simple subtraction of the identified minimum height from the identified maximum height.

In some implementations, the processor 6 can estimate the time at which the determined height change occurred (step 119). The processor 6 can estimate the time at which the height change occurred to be the time corresponding to the central sample in the portion of the height signal being analyzed, or alternatively the sample lying midway between the identified maximum height and the identified minimum height. An alternative way could be to memorize the indices of the maximum and minimum samples, and use these to derive the location (index) of the height change.

At this stage, the determined height change (and the estimated time at which the height change occurred, if determined) can be output by the filter/processor 6 and used in any subsequent processing (for example to determine if the user of the device 2 has fallen, etc.).

In step 121, the window is shifted along the estimated height signal, and steps 113-119 are repeated for the new portion of the height signal in the window. The window can be shifted by a single sample in step 121, or by a plurality of samples or a set time period.

Thus, the use of this ‘maxmin’ filter allows a height change to be identified, even when the height change in the estimated height signal is masked by artifacts in the signal.

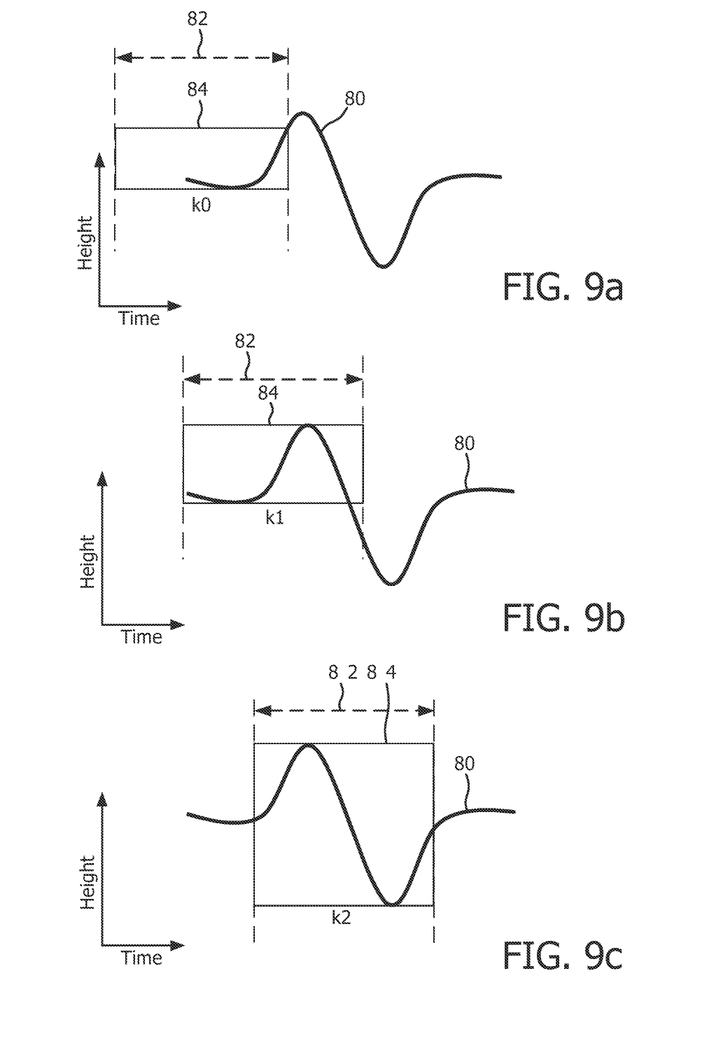

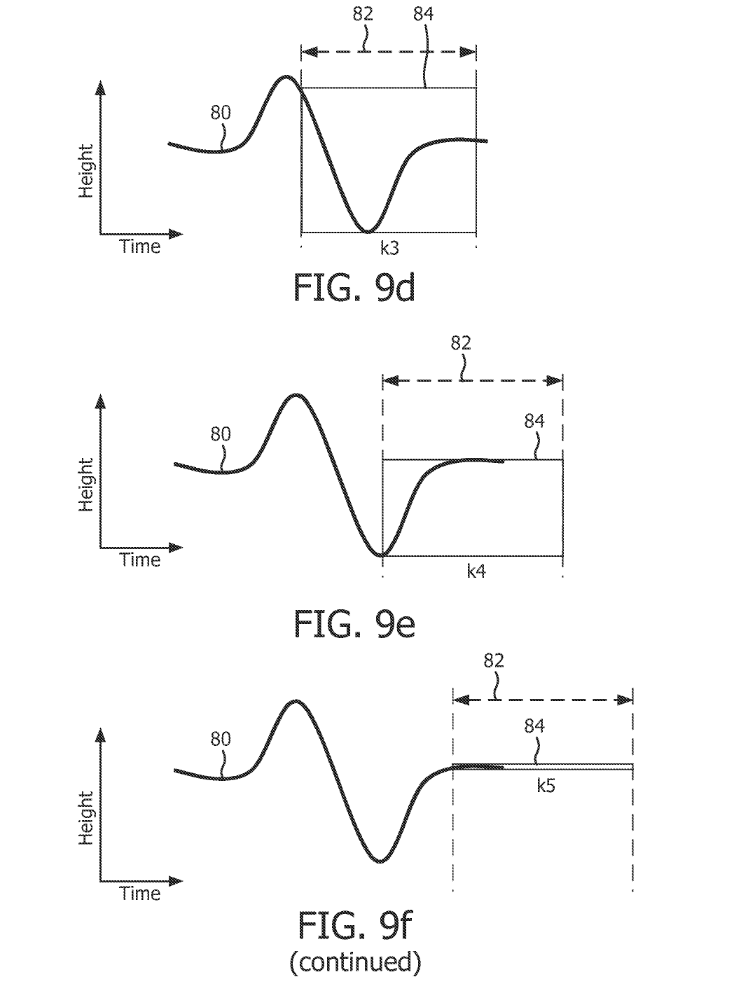

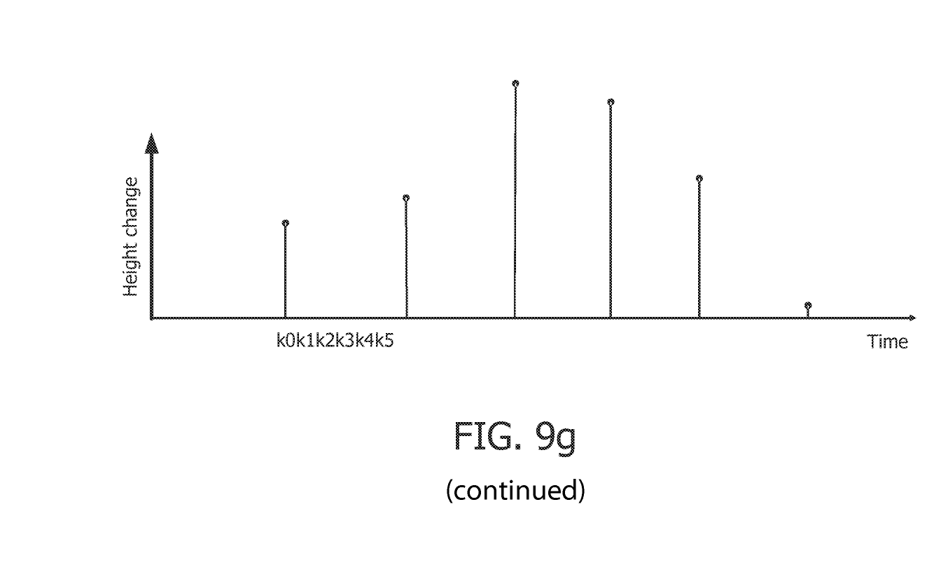

The graphs in FIG. 9 show the operation and output of the maxmin filter described above with reference to FIG. 8. Each of FIGS. 9(a)-(f) show an exemplary height signal 80 that corresponds to a height drop that has been windowed for respective time instants k0-k5 (with the window 82 being centered on the particular time instant). The time instants are exemplary, other spacings can be used. The windowed portion of the signal at each instant is labeled 82 and is shown between the vertical dashed lines. The box 84 in each figure is the same width as the window 82, and the upper and lower sides of the box 84 correspond to the maximum height value and minimum height value in the window 82 respectively. It will be appreciated that the change in height for a particular windowed portion 82 of the signal 80 is represented by the vertical height of the box 84.

FIG. 9(g) illustrates the output of the maxmin filter on signal 80, i.e. the change in height determined from the windowed portion 82 of the signal 80 at each of the instants k0-k5 shown in FIGS. 9(a)-(f) respectively.

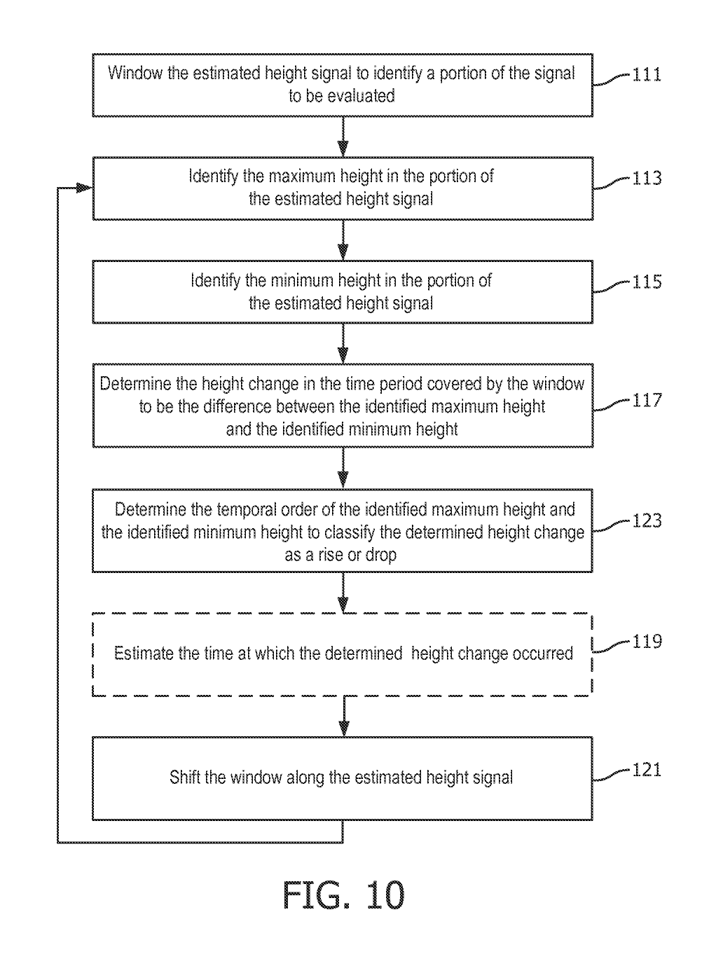

The operation of a second non-linear filter that can be used to detect if there has been a change in height or to output the particular change in height that has occurred is illustrated in FIG. 10. In this second preferred type of non-linear filter, steps 111-121 are identical to the ‘maxmin’ filter described above in FIG. 8, except that this filter comprises an additional step between step 117 (the step in which the height change is determined) and optional step 119 (in which the time of the height change is estimated).

In this additional step, labeled step 123 in FIG. 10, the processor 6 determines the temporal order of the identified maximum height and identified minimum height to determine whether the height change is a rise or drop. It can be seen from FIG. 1, signal 44, and FIG. 6, signal 70 that the maximum occurs after the minimum when the height change is a rise (left side), and the maximum occurs before the minimum when the height change is a drop (right side). Thus, in step 123 if the processor 6 determines that the maximum occurs after the minimum, then it classifies the determined height change as a rise, and if the processor 6 determines that the maximum occurs before the minimum, then it classifies the height change as a drop. In some implementations, the processor 6 can assign a sign (e.g. + or −) to the determined height change to indicate whether it is a rise or drop. This filter is referred to herein as ‘signed maxmin’ filter. The signed maxmin filter may be used in a fall detector, for example, since only the negatively signed outputs will be considered. Vice versa, when detecting a user standing-up, the negatively signed outputs will not cause the standing-up detector to be triggered. The sign can hence be used by a classifier (or detector) to optimize its accuracy.

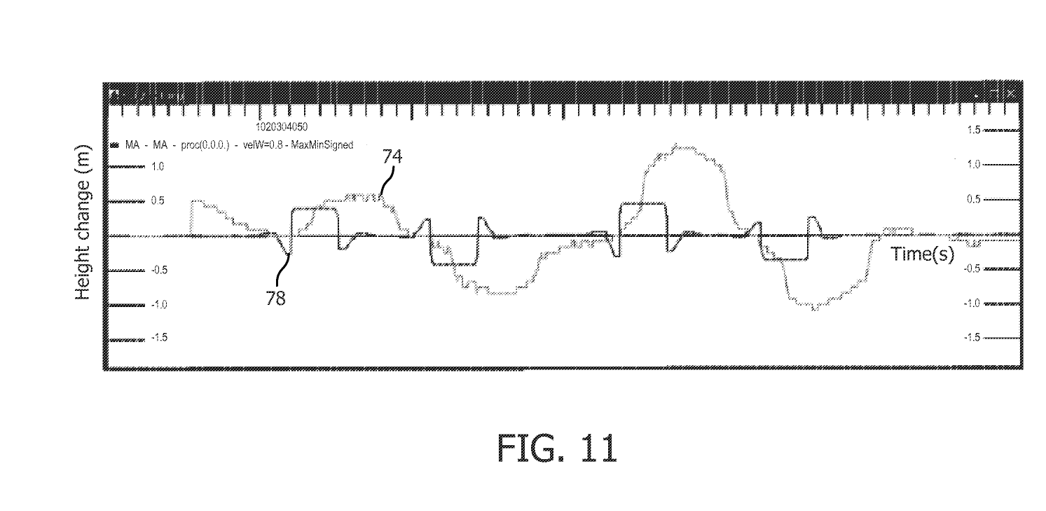

FIG. 11 illustrates the output 78 of the signed maxmin filter when it is passed over height signal 70 in FIG. 6. Signal 74 shows the height change derived from the air pressure sensor measurements as in FIG. 7. Thus, it can be seen that the use of the signed maxmin filter means that the height changes can be more easily identified.

Pseudo code representing the operation of the signed maxmin filter is set out below:

int N= sig.length;
int minT= 0;
double minV= sig[0];
for (int k=0;k<N;k++) if (sig[k]<minV) {minT= k; minV= sig[k];}
int maxT= 0;
double maxV= sig[0];
for (int k=0;k<N;k++) if (sig[k]>maxV) {maxT= k; maxV= sig[k];}
if (minT<maxT) return maxV−minV;

| | |
|---|---|
| else | return minV−maxV; |

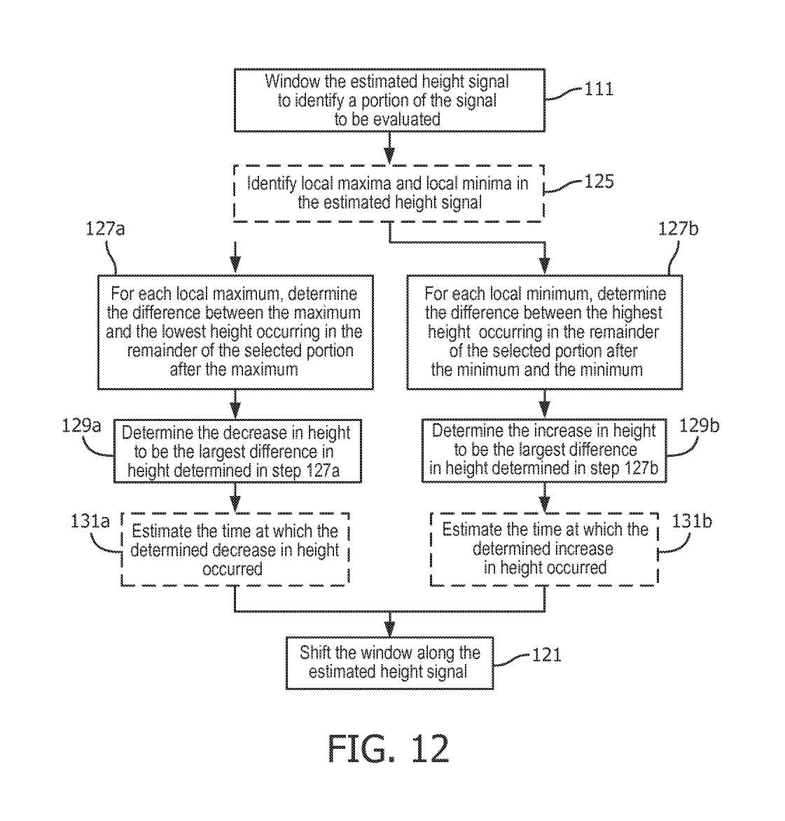

The operation of a third non-linear filter that can be used to detect if there has been a change in height or to output the particular change in height that has occurred is illustrated in FIG. 12. This filter is referred to as a ‘directed maxmin’ filter, as the filter is ‘directed’ to look for a height rise or for a height drop. Directing the filter in this way may be useful depending on the application to which the device 2 is put. For example, where the device 2 is a fall detector, the processor 6 can configure the filter/processing to look for height drops, and when it wants to detect whether the user has stood up again, after the fall, it starts looking for a rise. In another example, where the device 2 is a bed exit detector, the processor 6 can configure the filter/processing to look for a rise, for example in the vicinity of a posture change (which can be detected from the accelerometer signal using suitable processing techniques). As with the signed maxmin filter, the directed maxmin can help to improve the accuracy of a subsequent classifier or detector.

The principle of the directed maxmin filter, when it looks for a rise, is to find the largest difference between the samples in the estimated height signal within the windowed portion where the ‘maximum’ of the two should occur after the ‘minimum’ (with each sample representing the estimated height value at that instant). When it looks for a drop the ‘minimum’ is required to occur after the ‘maximum’. Since the temporal order is constrained the ‘maximum’ and ‘minimum’ are not necessarily the maximum or minimum over the whole window portion. Also, note the largest difference is searched for, where the largest difference is not necessarily the numerically largest difference in the window portion, but could be defined in a similar way as maximum and minimum are defined. For example, the second largest difference or an average could be selected. Such a definition could be preferred, for example, to reduce the effect of potential outliers. An example of the operation of the directed maxmin filter is given below.

Assume the following local maximum or local minimum samples occur in the windowed portion of the estimated height signal:

s[k0]=−7, s[k1]=7, s[k2]=−9, s[k3]=6, s[k4]=−10,

where k0<k1<k2<k3<k4 indicate the sample index (not necessarily one after the other, but increasing time). The maxmin filter described above with reference to FIG. 8 would return 17 and the signed maxmin described above with reference to FIG. 10 would return −17. The directed maxmin, when looking for a drop, would also return the value −17. However, when looking for a rise, it would return 15. This is because the sample at k0 pairs with the sample at k1 for a largest (given k0) rise of 14, but the sample at k2 pairs with k3 to yield 15, which is larger. k2 is not the overall minimum in the window and k3 is not the overall maximum in the window. The sample at k2 would not be paired with the one at k1, since the temporal order is against rising direction.

An embodiment of the directed maxmin is depicted in FIG. 12. In FIG. 12, the left-hand part of the flow chart with step labels ending in ‘a’ corresponds to the operation of the filter when directed to look for a decrease in height (drop), and the right-hand part of the flow chart with step labels ending in ‘b’ corresponds to the operation of the filter when directed to look for an increase in height (rise).

The first step in the operation of this filter (step 111), the windowing of the estimated height signal, is the same as for the two other filters described above.

In the next step (step 125), which is optional (but helps to make the subsequent processing steps more efficient), all the local maxima and local minima in the estimated height signal are identified.

When the filter is directed to identify height decreases, the next step (step 127a) comprises, for each local maximum in the window, identifying the lowest height that occurs after the local maximum being considered. This ‘lowest height’ will correspond to a local minimum in the windowed portion of the height signal (and could alternatively be described as the global minimum of the remainder of the windowed portion of the height signal after the local maximum being considered). In addition, for each local maximum, the difference between the height of the local maximum and the respective lowest height is determined.

Once the difference in height has been determined for each of the local maxima in the windowed portion of the signal, the process moves to step 129a in which the decrease in height for the windowed portion is determined to be the largest difference in height determined in step 127a. This decrease in height forms the output of the directed-drop maxmin filter.

Optionally, the time at which the height decreased can be identified in step 131a in a similar way to step 119 in FIG. 6.

The window can then be shifted in step 121 in a similar way to FIG. 6, and the processing repeated for the samples in the shifted window.

When the filter is directed to identify height increases (which might be used after a fall has been detected and the processor 6 is monitoring the user to determine whether they have got up, or to detect a bed exit), the first step, step 127b, comprises, for each local minimum in the window, the processor 6 identifying the largest height that occurs after the local minimum being considered. This ‘largest height’ will correspond to a local maximum in the remaining portion of the windowed signal after the minimum height being considered (and could alternatively be described as the global maximum of the remainder of the windowed portion of the height signal after the local minimum being considered). In addition, for each local minimum, the difference between the respective highest height and the height of the local minimum is determined.

In step 129b, the amount by which the height increase for the windowed portion of the signal is determined to be the largest difference found in step 127b. This increase in height forms the output of the directed-rise maxmin filter. Again, optionally, the time at which the height increased can be identified in step 131b in a similar way to step 119 in FIG. 6.

In the case of the directed maxmin filter (rise or drop), it will be appreciated that the maximum position value and minimum position value referred to in step 103 of FIG. 3 above correspond to the height values of the identified maximum and minimum that produce the largest difference in height found in step 129a or 129b.

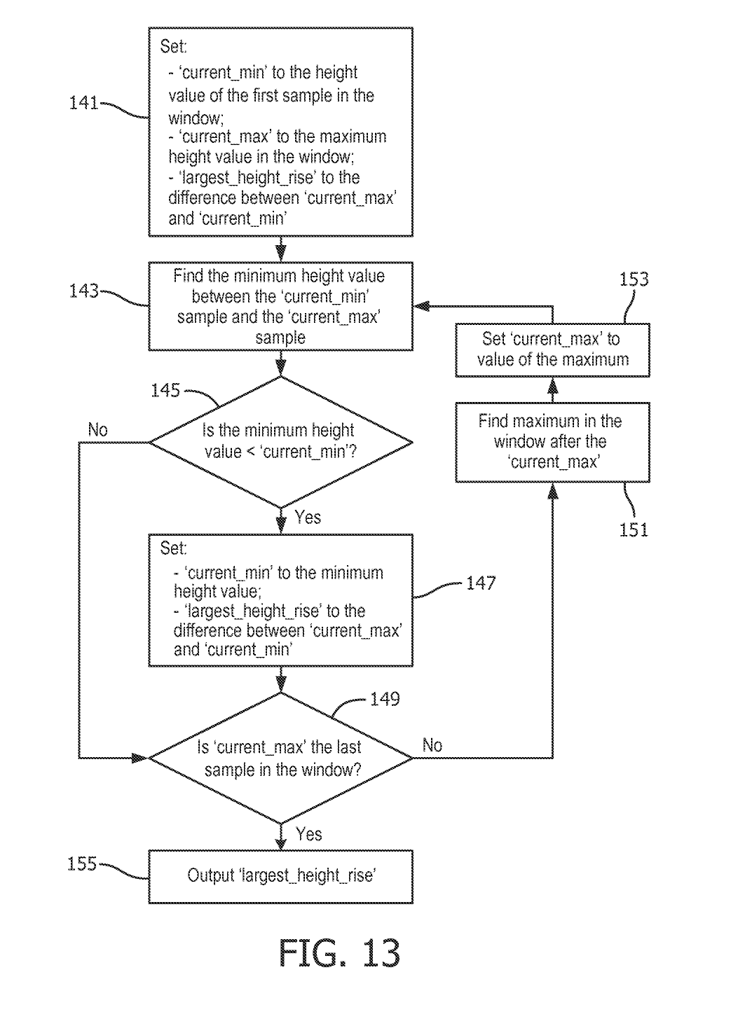

FIG. 13 illustrates an alternative method of implementing a directed rise maxmin filter from FIG. 12. The steps in FIG. 13 take the place of steps 125-129 in FIG. 12. Although FIG. 13 relates to a directed rise maxmin filter, it will be appreciated by those skilled in the art how the illustrated process can be adapted to search for height decreases.

For the filter that is directed to identify height increases, the first step after windowing the height signal, step 141, is to initialize the values of three parameters. Parameter ‘current_min’ is set to the height value of the first sample in the windowed portion of the signal, parameter ‘current_max’ is set to the height value of the ‘maximum’ in the window, e.g. as described above in FIG. 8 step 113, and parameter ‘largest_height_rise’ is set to the difference between the values of ‘current_min’ and ‘current_max’. In the description below ‘current_min’ and ‘current_max’ are also used to indicate the time index/instant in the window.

Then, in the following step, step 143, the processor 6 searches for the minimum height value between the ‘current_min’ sample and the ‘current_max’ sample. In step 145, the minimum height value is compared to the value of ‘current_min’ and it is determined whether the minimum height value is smaller than the value of ‘current_min’. If the minimum height value is smaller than the value of ‘current_min’, the method moves to step 147 in which the parameter ‘current_min’ is set to the minimum height value and the parameter ‘largest_height_rise’ is recalculated from the new value for the ‘current_min’ and the previously-set value for ‘current_max’. The method then proceeds to step 149.

If in step 145 it is found that the minimum height value is larger than the value of ‘current_min’, the method skips step 147 and proceeds straight to step 149.

In step 149, it is determined whether the sample that corresponds to the value for ‘current_max’ is the last sample in the window. If it is not the last sample in the window, the process moves to step 151 in which the next maximum in the window after the ‘current_max’ sample is identified.

The value of this next maximum is set as the value for the parameter ‘current_max’ (step 153). The method then returns to step 143 and repeats.

If in step 149 it is determined that the sample that corresponds to the value for ‘current_max’ is the last sample in the window, the method moves to step 155 and the current value for the parameter ‘largest_height_rise’ is output as the height_rise. The time at which the determined height change occurred can then be determined (step 131 in FIG. 12) and the window shifted along the signal (step 121 in FIG. 12).

It is noted that in step 143 and 151 the ‘current_min’ and ‘current_max’ are excluded from the search. Since the search in the described form may return to the next sample, and will be doing that for a number of iterations, a further optimization can be implemented as will be clear to those skilled in the art.

In another alternative implementation of a directed rise maxmin filter, the next step after windowing the height signal is to identify the sample index and height value that will yield the largest height rise relative to the first sample in the portion of the estimated height signal. This identified sample is called ‘maximum’ hereafter. This step is essentially the same as step 113 in FIG. 8 (where in addition the sample index is stored). However, in the following step, (corresponding to step 127a), the processor 6 then searches for a sample after the first that is smaller than that first sample. Such a sample, called ‘smaller’ sample, may form a larger rise than the rise found so far. This is certainly the case if the memorized ‘maximum’ sample is after this newly found ‘smaller’ sample. If the ‘maximum’ is before the found ‘smaller’ a new test is to be made whether another pair can be found with the ‘smaller’ sample, where the pair forms a larger difference than the difference found so far. In the example above, after finding the pair k0-k1, the sample k2 is smaller and it can pair with k3 for a larger (rise) height difference.

Pseudo code representing the operation of the directed maxmin filter is set out below:

int N= sig.length;//sig is portion in current window
int extT= 0;
double extV= sig[0];
double mm= 0;//threshold
if (rise) {//search for rise

for (int k=1;k<N;k++) if (sig[k]−extV>mm) {

extT= k;
mm= sig[k]−extV;
}

for (int k0=1;k0<N;k0++) if (sig[k0]<extV) {

extV= sig[k0];
if (extT>k0) mm= sig[extT]−extV;
else for (int k1=k0+1;k1<N;k1++)

if (sig[k1]−extV>mm) {

extT= k1;
mm= sig[k1]−extV;

}
}

} else {//search for drop

for (int k=1;k<N;k++) if (sig[k]−extV<mm) {

extT= k;
mm= sig[k]−extV;
}

for (int k0=1;k0<N;k0++) if (sig[k0]>extV) {

extV= sig[k0];
if (extT>k0) mm= sig[extT]−extV;
else for (int k1=k0+1;k1<N;k1++)

if (sig[k1]−extV<mm) {

extT= k1;

mm= sig[k1]−extV;

}

}

}
return mm;

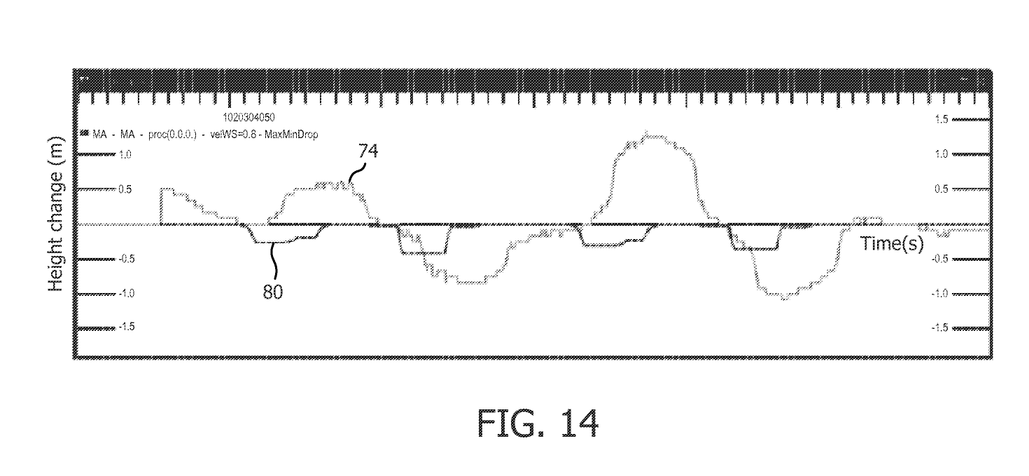

FIG. 14 illustrates the output 80 of the directed maxmin filter when directed to identify drops when it is passed over height signal 70 in FIG. 6. Signal 74 shows the height change derived from the air pressure sensor measurements as in FIGS. 7 and 11. It can be seen that the decreases in height are clearly defined in the output signal 80 of the drop-directed maxmin filter.

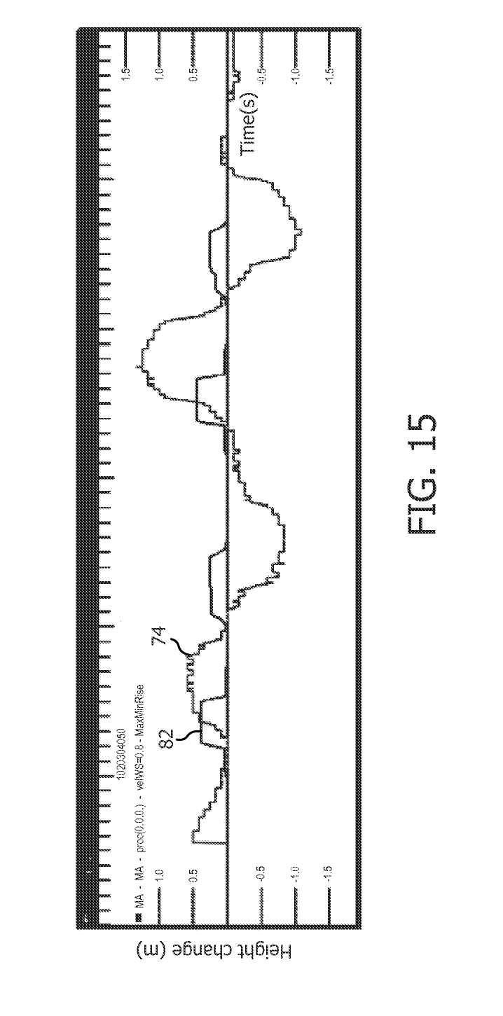

FIG. 15 illustrates the output 82 of the directed maxmin filter when directed to identify rises when it is passed over height signal 70 in FIG. 6. Signal 74 shows the height change derived from the air pressure sensor measurements as in FIGS. 7, 11 and 13. It can be seen that the increases in height are clearly defined in the output signal 80 of the drop-directed maxmin filter.

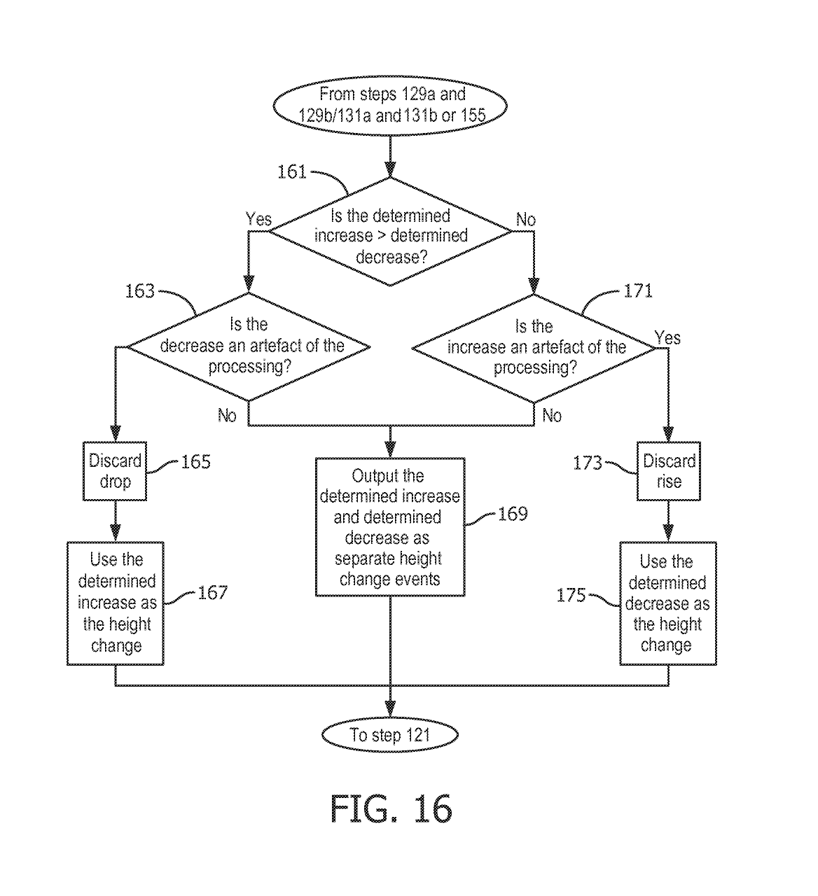

The operation of a fourth non-linear filter that can be used to detect if there has been a change in height or to output the particular change in height that has occurred is illustrated in FIG. 16. This filter is based on the ‘directed maxmin’ filter shown in FIGS. 12 and 13 and as described above. In the fourth non-linear filter, both the directed maxmins are computed (i.e. steps 127a-129a/131a and steps 127b-129b/131b of FIG. 12 are performed or the steps in FIG. 13 for both a rise and a drop are performed), which yields both a rise and a drop from a particular windowed portion of the estimated height signal.

As shown in line 44 of FIG. 1 and in line 55 of FIG. 5(f), a height rise is preceded and followed by apparent height drops (and vice versa for a height drop). It has been observed that the preceding and following artifacts are of smaller size than the desired height change. When the filter's window is positioned appropriately over the estimated height signal, both artifacts will be found by the processor 6. Thus, in this non-linear filter, a drop is removed when it is closely preceded or followed by a rise having a larger size. Likewise, a rise is removed when it is closely preceded or followed by a drop having a larger size. In this way, drops or rises arising due to the filter transients will not be output by the filter and thus will not be used in subsequent processing.

The steps shown in FIG. 16 take place after the steps shown in FIG. 12 or 13 for the ‘directed maxmin’ filter. Thus, both a height decrease and a height increase have been determined and they are compared in step 161 to identify which is largest (i.e. has the highest magnitude).

If the determined height increase is greater than the determined height decrease, then the method moves to step 163 in which it is determined whether the determined height decrease is likely to be an artifact of the processing of the accelerometer or other movement signal, or whether it corresponds to an actual (physical) height decrease of the device 2. For example, a height decrease is more likely to be an artifact if it occurs close (in time) to the determined height increase. Thus, in some embodiments, step 163 comprises determining whether the determined height decrease occurs within a predetermined time period of the determined height increase. In other words, it is determined if the time difference between the occurrence of the height increase and the height decrease is less than the predetermined time period. This time period is denoted Δt and can be of the order of one second (e.g. 0.1 to 1 seconds).

If the time difference between the occurrence of the height increase and the height decrease is less than the predetermined time period (i.e. the decrease occurs close to the increase), the determined height decrease is discarded (step 165) and the filter outputs the determined height increase as the height change in the current window (step 167).

If the time difference between the occurrence of the height increase and the height decrease is greater than the predetermined time period (i.e. the decrease does not occur close to the increase), then both the determined height increase and the determined height decrease can be indicated by the filter as separate height change events for the current window (step 169).

Returning to step 161, if the determined height increase is less than the determined height decrease, then the method moves to step 171 (which is analogous to step 163 above) in which it is determined whether the determined height increase is likely to be an artifact of the processing of the accelerometer or other movement signal, or whether it corresponds to an actual (physical) height increase of the device 2. Thus, in some embodiments, step 171 comprises determining whether the determined height increase occurs within a predetermined time period of the determined height decrease, i.e. it is determined if the time difference between the occurrence of the height increase and the height decrease is less than the predetermined time period. As above, this time period is denoted Δt and can be of the order of one second, for example between 0.1 and 1 second.

If the time difference between the occurrence of the height increase and the height decrease is less than the predetermined time period (i.e. the increase occurs close to the decrease), the determined height increase is discarded (step 173) and the filter outputs the determined height decrease as the height change in the current window (step 175). If the time difference between the occurrence of the height decrease and the height increase is greater than the predetermined time period (i.e. the increase does not occur close to the decrease), then both the determined height decrease and the determined height increase can be indicated by the filter as separate height change events for the current window (step 169).

As with the previous filters, once the height change(s) have been determined, the window can be shifted (step 121) and the operation of the filter repeated.

In any of the non-linear filters described above, the size of the window applied to the height signal can be a time period that is suitable for the application to which the device 2 has been put, for example 5 seconds or any other time between 2 to 12 seconds for a fall detector device. The number of samples in the height signal in the window is given by multiplying this duration by the sampling frequency.

It will be appreciated that in any of the preferred filter types described above, the computational load on the processor 6 can be reduced by only analyzing a subset of the samples in the window, for example only every other sample, or perhaps all of the samples in a central portion of the window can be analyzed, along with a subset of the remaining samples in the window.

It will also be appreciated that alternative implementations of the described non-linear filters are possible. For example, the step of identifying the maximum height and minimum height (e.g. steps 113 and 115) can comprise taking the mean or median of a predetermined number (e.g. 3) of the samples in the window with the largest or smallest height values respectively.

Alternatively, the step of identifying the maximum height and minimum height can be generalized to identifying the m-th and n-th ranked samples in the windowed portion, with the m-th rank corresponding to a low value sample or the lowest value sample (i.e. the minimum) and the n-th rank corresponding to a high value sample or the highest value sample (i.e. the maximum). In this implementation, in terms of the calculation of the change in height, the m-th rank is considered the ‘minimum’ value for the height (since by taking the m-th rank the samples with the lowest m−1 height values are effectively discarded) and the n-th rank is considered the ‘maximum’ value for the height (since taking the n-th rank the samples with the highest N-n height values are effectively discarded, with N being the number of samples in the windowed portion), with the height change being determined using the identified ‘maximum’ and the identified ‘minimum’. Suitable values for m and n can depend on the level of outlier values or noise expected to occur in the estimated height signal. For example, the values of m and n can be selected so that up to the lowest and highest 5% of the estimated height samples are discarded respectively. Identifying the m-th and n-th ranked samples (where the m-th and n-th ranked samples are not the lowest and highest value samples respectively) can be useful where the estimated height signal contains outlier values and noise, since it is possible the use of the m-th and n-th rank will mean that these outlier values are ignored when determining the height change. In some implementations, the values of m and n can be adapted to the actual noise characteristics in the estimated height signal, or, for example, in the case of fall detection, adapted to the observed impact.

In some embodiments, by varying the window size and/or by observing the filter's response at subsequent times of the window (i.e. when sliding the window over the signal) further refinement in the height estimation can be incorporated. If, for example, a rise occurs the filter's response will show that rise when the window moves over that event. When the window first touches the rise, the returned value will be small, but it will increase when the window covers more of the event. Finally, the output drops again when the window has passed the event. This effect is shown in FIGS. 9, 11, 13 and 15. Similarly, instead of moving the window (with the size of the window remaining constant), the window can be expanded (i.e. the location of the window stays fixed). Incorporating more samples will affect the outcome if the expansion of the window results in the window touching on a rise (or drop) in the signal.

It can be seen that the use of the non-linear filters described above is particularly advantageous when used on a height signal obtained using the process shown in FIG. 4 when the first and second filters are linear filters (for example moving average filters), because the use of linear filters in the process in FIG. 4 is easier and requires less processing power than using the non-linear filters described above and in European/International patent application no. PCT/IB2012/054192. However, it will be appreciated that a non-linear filter can also provide an indication of the change in height when used on a height signal obtained using two non-linear filters.

When the height change detection/estimation algorithm is used in a fall detector, there are multiple ways in which the detected or estimated change in height can be used in the decision logic for detecting a fall. For example, it can be determined whether the estimated change in height exceeds a (downwards) threshold, and if so, this height change can be used to initiate additional processing of the movement signals to identify if the signals contain or indicate any further characteristics of a fall. For example, if the computed height change drops below a certain threshold, e.g. −0.5 m, the fall-detection algorithm can compute other feature values from the movement signal, such as impact and orientation change, and combine them in a classifier that is trained to distinguish falls from non-falls.

In another design, another feature, for example impact, could be used to trigger the computation of the other feature values. In that case the height estimation and height change computation by the non-linear filter might only be applied on the segment of the acceleration signal around the sample or samples corresponding to the impact acceleration (and in this case a window with varying size as described above may be used). Where the filter is only applied on a segment of the signal around the sample, the described refinements can be further optimized. For example, since the detector is looking for a fall, the non-linear filter can be directed to identify a drop (around/before the impact sample), which is then used in the further fall classifier. In addition, the non-linear filter can be directed to look for a rise, preferably greater than a specified amount (e.g. 0.5-1 meter) in the time period (e.g. 30 seconds) after the identified drop. If an identified rise is of a larger value than the identified drop, for example, or greater than the specified amount, the fall detection algorithm could decide to suspend further processing on that part of the movement signal and determine that no fall has occurred.

There is therefore provided a method and apparatus for detecting a change in position of a device based on measurements of the movement experienced by the device.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. Some aspects of the invention and features of the embodiments are summarized as follows:

According to a first aspect of the invention, there is provided a method for determining the change in horizontal or vertical position of a device, the method comprising:

obtaining a signal that represents an estimate of the position of the device in a horizontal or vertical direction over time;

identifying a maximum position value and a minimum position value from a selected portion of the signal representing the estimate of the position of the device; and

determining the change in position over the selected portion of the signal as the difference between the identified maximum position value and the identified minimum position value.

### Embodiment 1

A method as defined according to the first aspect of the invention, wherein the maximum position value is the position value corresponding to a maximum in the signal and the minimum position value is the position value corresponding to a minimum in the signal.

### Embodiment 2

A method as defined according to the first aspect of the invention, wherein the maximum position value is an average of a plurality of the highest position values indicated in the signal and the minimum position value is an average of a plurality of the lowest position values indicated in the signal.

### Embodiment 3

A method as defined according to the first aspect of the invention, wherein the minimum position value corresponds to a first rank value and the maximum position value corresponds to a second rank value, the first rank value and second rank value corresponding to the respective values at first rank order position and second rank order position after permuting the signal values in the selected portion of the signal in the order of increasing values, and where the first rank order position precedes the second rank order position.

### Embodiment 4

A method as defined according to the first aspect of the invention or any of embodiments 1-3, further comprising the step of:

determining a time at which the determined change in position occurred.

### Embodiment 5

A method as defined in embodiment 4, wherein the step of determining a time at which the determined change in position occurred comprises:

determining the times at which the identified maximum position value and minimum position value occurred; and

determining the time at which the determined change in position occurred as a time point between the times of the identified maximum position value and minimum position value.

### Embodiment 6

A method as defined according to the first aspect of the invention or in any preceding embodiment, further comprising the step of:

determining the temporal order in which the identified maximum position value and minimum position value occurred in the signal; and

determining the direction of the determined position change based on the determined temporal order.

### Embodiment 7

A method as defined in embodiment 6, wherein the signal represents an estimate of the height of the device, and the step of determining the direction of the determined position change comprises determining that the position change is a height increase if the identified minimum position value occurred before the identified maximum position value and determining that the position change is a height decrease if the identified minimum position value occurred after the identified maximum position value.

### Embodiment 8

A method as defined according to the first aspect of the invention or in any of embodiments 1-5, wherein the step of identifying a maximum position value and a minimum position value from a selected portion of the signal representing the estimate of the position of the device comprises:

identifying a maximum position value and a minimum position value to give a change in position of the device in a predefined direction, wherein the identified maximum position value and the identified minimum position value are the position values in the signal that have the largest difference, where the identified minimum position value and the identified maximum position value occur in a predefined temporal order in the signal.

### Embodiment 9

A method as defined according to the first aspect of the invention or in any of embodiments 1-5, wherein the step of identifying a maximum position value and a minimum position value from a selected portion of the signal representing the estimate of the position of the device comprises:

identifying a maximum position value and a minimum position value to give a change in position of the device in a first direction, wherein the identified maximum position value and the identified minimum position value are the position values in the signal that have the largest difference where the identified minimum position value occurs before the identified maximum position value in the signal.

### Embodiment 10

A method as defined in embodiment 9, wherein the step of identifying a maximum position value and a minimum position value to give a change in position of the device in a first direction comprises:

for each local minimum in the selected portion, determining the difference in position between the value of the local minimum and the highest signal value occurring in the selected portion after the local minimum; and

determining the minimum position value and the maximum position value to be the values of the local minimum and highest signal value pair having the largest difference.

### Embodiment 11

A method as defined in embodiment 9 or embodiment 10, wherein the signal represents an estimate of the height of the device, and wherein the maximum position value and the minimum position value are identified such that they represent an increase in height.

### Embodiment 12

A method as defined according to the first aspect of the invention or in any of embodiments 1-5, wherein the step of identifying a maximum position value and a minimum position value from a selected portion of the signal representing the estimate of the position of the device comprises:

identifying a maximum position value and a minimum position value to give a change in position of the device in a second direction, wherein the identified maximum position value and the identified minimum position value are the position values in the signal that have the largest difference where the identified minimum position value occurring after the identified maximum position value in the signal.

### Embodiment 13

A method as defined in embodiment 12, wherein the step of identifying a maximum position value and a minimum position value to give a change in position of the device in a second direction comprises:

for each local maximum in the selected portion, determining the difference in position between the value of the local maximum and the lowest signal value occurring in the selected portion after the local maximum; and

determining the maximum position value and the minimum position value to be the values of the local maximum and lowest signal value pair having the largest difference.

### Embodiment 14

A method as defined in embodiments 11 or 12, wherein the signal represents an estimate of the height of the device, and wherein the maximum position value and the minimum position value are identified such that they represent a decrease in height.

### Embodiment 15

A method for determining the change in horizontal or vertical position of a device, comprising:

determining a change in position of the device in a first direction as defined in any of embodiments 9-11;

determining a change in position of the device in a second direction, that is opposite to the first direction, as defined in any of embodiments 12-14;

comparing the determined change in position in the first direction to the determined change in position in the second direction;

if the determined change in position in the first direction is greater than the determined change in position in the second direction, determining whether the change in position in the second direction is an artifact of the signal, and if so, outputting the determined change in position in the first direction as the position change in the selected portion, otherwise outputting both the determined change in position in the first direction and the determined change in position in the second direction as position changes that occurred in the selected portion; and

if the determined change in position in the first direction is less than the determined change in position in the second direction, determining whether the change in position in the first direction is an artifact of the signal, and if so, outputting the determined change in position in the second direction as the position change in the selected portion, otherwise outputting both the determined change in position in the first direction and the determined change in position in the second direction as position changes that occurred in the selected portion.

According to a second aspect of the invention, there is provided a computer program product, comprising a computer readable medium having computer program code embodied therein, the computer program code being configured such that, upon execution by a computer or processor, the computer or processor performs the method as defined according to the first aspect of the invention or in any of embodiments 1 to 15.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for determining the change in horizontal or vertical position of a device, the method comprising:
obtaining a signal that represents an estimate of the position of the device in a horizontal or vertical direction over time;
identifying a maximum position value and a minimum position value from a selected portion of the signal representing the estimate of the position of the device; and
determining the change in position over the selected portion of the signal as the difference between the identified maximum position value and the identified minimum position value.

2. The method as claimed in claim 1, wherein the maximum position value is the position value corresponding to a maximum in the signal and the minimum position value is the position value corresponding to a minimum in the signal.

3. The method as claimed in claim 1, wherein the maximum position value is an average of a plurality of the highest position values indicated in the signal and the minimum position value is an average of a plurality of the lowest position values indicated in the signal.

4. The method as claimed in claim 1, wherein the minimum position value corresponds to a first rank value and the maximum position value corresponds to a second rank value, the first rank value and second rank value corresponding to the respective values at first rank order position and second rank order position after permuting the signal values in the selected portion of the signal in the order of increasing values, and where the first rank order position precedes the second rank order position.

5. The method as claimed in claim 1, further comprising the step of:
determining a time at which the determined change in position occurred.

6. The method as claimed in claim 5, wherein the step of determining a time at which the determined change in position occurred comprises:
determining the times at which the identified maximum position value and minimum position value occurred; and
determining the time at which the determined change in position occurred as a time point between the times of the identified maximum position value and minimum position value.

7. The method as claimed in claim 1, further comprising the step of:
determining the temporal order in which the identified maximum position value and minimum position value occurred in the signal; and
determining the direction of the determined position change based on the determined temporal order.

8. The method as claimed in claim 7, wherein the signal represents an estimate of the height of the device, and the step of determining the direction of the determined position change comprises determining that the position change is a height increase if the identified minimum position value occurred before the identified maximum position value and determining that the position change is a height decrease if the identified minimum position value occurred after the identified maximum position value.

9. The method as claimed in claim 1, wherein the step of identifying a maximum position value and a minimum position value from a selected portion of the signal representing the estimate of the position of the device comprises:
identifying a maximum position value and a minimum position value to give a change in position of the device in a predefined direction, wherein the identified maximum position value and the identified minimum position value are the position values in the signal that have the largest difference, where the identified minimum position value and the identified maximum position value occur in a predefined temporal order in the signal.

10. The method as claimed in claim 1, wherein the step of identifying a maximum position value and a minimum position value from a selected portion of the signal representing the estimate of the position of the device comprises:
identifying a maximum position value and a minimum position value to give a change in position of the device in a first direction, wherein the identified maximum position value and the identified minimum position value are the position values in the signal that have the largest difference where the identified minimum position value occurs before the identified maximum position value in the signal.

11. The method as claimed in claim 1, wherein the step of identifying a maximum position value and a minimum position value from a selected portion of the signal representing the estimate of the position of the device comprises:
identifying a maximum position value and a minimum position value to give a change in position of the device in a second direction, wherein the identified maximum position value and the identified minimum position value are the position values in the signal that have the largest difference where the identified minimum position value occurring after the identified maximum position value in the signal.

12. An apparatus, comprising:
processing means that is configured to:
obtain a signal that represents an estimate of the position of a device in a horizontal or vertical direction over time;
identify a maximum position value and a minimum position value from a selected portion of the signal representing the estimate of the position of the device; and
determine the change in position over the selected portion of the signal as the difference between the identified maximum position value and the identified minimum position value.

13. A device that is configured to be worn by a user, the device comprising:
an accelerometer that measures the acceleration acting on the device in three dimensions; and
an apparatus as claimed in claim 12, wherein the processing means is configured to obtain the signal that represents the estimate of the position of the device over time using the measurements from the accelerometer.

14. A system, comprising:
a device that is configured to be worn by a user, the device comprising an accelerometer that measures the acceleration acting on the device in three-dimensions; and
a base unit that is configured to communicate with the device, and that comprises an apparatus as claimed in claim 12, wherein the processing means is configured to obtain the signal that represents the estimate of the position of the device over time using the measurements from the accelerometer.

15. A computer program product, comprising a computer readable medium having computer program code embodied therein, the computer program code being configured such that, upon execution by a computer or processor, the computer or processor performs the method as claimed in claim 1.
